(19) United States
(12) Patent Application Publication
(10) Pub. No.: US 2007/0294685 A1
(43) Pub. Date: Dec. 20, 2007

(54) PROGRAM UPGRADE SYSTEM AND METHOD FOR OTA-CAPABLE PORTABLE DEVICE

(75) Inventor: Sung Jo OH, Suwon-si (KR)

Correspondence Address: THE FARRELL LAW FIRM, P.C., 333 EARLE OVINGTON BOULEVARD, SUITE 701, UNIONDALE, NY, 11553, US

(73) Assignee: SAMSUNG ELECTRONICS CO., LTD., Suwon-si (KR)

(21) Appl. No.: 11/765,191

(22) Filed: Jun. 19, 2007

(30) Foreign Application Priority Data
Jun. 19, 2006 (KR) 2006-0054746

(51) Int. Cl. G06F 9/44

(52) U.S. Cl. 717/168

(57) ABSTRACT

A program upgrade system and method for portable device using an over-the-air programming mechanism, that includes an upgrade package processor for generating an upgrade package for a program and an upgrade package server allowing a recipient device to download the upgrade package. The method includes generating, the upgrade package on the basis of differences between a first and second versions of the program at the upgrade package processor; notifying, the recipient device of an issuance of the upgrade package at the upgrade package server; downloading, the upgrade package from the upgrade package server to the recipient device; installing the upgrade package in a first memory; and merging the upgrade package and the first version of the program to be loaded as the second version of the program on a volatile memory in response to an upgrade command.

### PRIORITY

This application claims priority under 35 USC §119 to an application entitled “PROGRAM UPGRADE SYSTEM AND METHOD FOR OTA-CAPABLE PORTABLE DEVICE” filed in the Korean Intellectual Property Office on Jun. 19, 2006 and assigned Serial No. 2006-0054746, the contents of which are incorporated herein by reference.

### BACKGROUND OF THE INVENTION

1. Field of the Invention

The present invention relates to a system upgrade method and, in particular, to a system and method for updating a program (including an operating firmware and application software) of a portable device using an over-the-air programming mechanism.

2. Description of the Related Art

Electronic devices, such as mobile phones and personal digital assistants (PDAs), contain firmware and application software that are provided by the manufacturers of the electronic devices, telecommunication carriers, or third parties. Such firmware and application software may contain software bugs requires version upgrades. In order to fix and upgrade the firmware and application software, a user visits a customer care center operated by the manufacturer or the carrier. In the case of an over-the-air (OTA) capable device, the firmware or software upgrade can be performed by the OTA mechanism in which the firmware or software upgrades are distributed to the device over the air.

In order to use the OTA upgrade process, the electronic device incorporates a download module for downloading an upgrade package and an upgrade processing module for performing the upgrade of target firmware or software with the downloaded upgrade package. However, most conventional OTA capable devices are limited in OTA operation stability.

### SUMMARY OF THE INVENTION

The present invention has been made in an effort to solve at least the above problems, and the present invention provides a program upgrade system and method for an OTA-capable mobile phone that enables updating firmware with an upgrade package received over the air.

The present invention provides a program upgrade system and method for an OTA-capable portable device that enables updating firmware of the portable device by combining an upgrade package, which is generated on the basis of differences between an old version firmware and a new version firmware, over the air with the old version firmware installed in the portable device.

The present invention provides a program upgrade system and method for an OTA-capable portable device that enables updating firmware with an upgrade package received over the air, the upgrade package containing history data, map data having index information for indicating a relationship of the upgrade package and upgrade target version of the program, and upgrade data representing differences between two versions of the program.

The present invention provides a program upgrade system and method for an OTA-capable portable device that enables producing an upgrade package containing upgrade data created on the basis of a difference between new and reference versions of firmware, history data for indicating a relationship of the upgrade package and upgrade target version of the program of the firmware, and map data for mapping the blocks of the two versions.

The present invention provides a program upgrade system and method for an OTA-capable portable device that enables producing an upgrade package containing upgrade data created on the basis of a difference between new and old versions of firmware, history data for indicating a relationship of the upgrade package and upgrade target version of the program of the firmware, and map data for mapping the blocks of the two versions.

The present invention provides a program upgrade system and method for an OTA-capable portable device that enables updating firmware of the portable device by combining a reference firmware installed in the portable device and an upgrade package downloaded over the air.

The present invention provides a program upgrade system and method for an OTA-capable portable device that enables updating firmware of the portable device by combining a reference firmware installed in the portable device with at least one upgrade package downloaded over the air.

In accordance with an aspect of the resent invention, the above and other objects are accomplished by a program upgrade method in a network including an upgrade package processor for generating an upgrade package for a program and an upgrade package server allowing a recipient device to download the upgrade package. The program upgrade method includes generating, at the upgrade package processor, the upgrade package on the basis of differences between a first version and a second version of the program; notifying, at the upgrade package server, more than one recipient device of an issuance of the upgrade package; downloading, at the recipient device, the upgrade package from the upgrade package server; installing the upgrade package in a non-volatile memory; and merging the upgrade package and the first version to be loaded as the second version in a volatile memory in response to an upgrade command.

In accordance with another aspect of the present invention, the above and other objects are accomplished by a program upgrade method in a network including an upgrade package processor for generating an upgrade package for a program and an upgrade package server allowing a recipient device to download the upgrade package. The program upgrade method includes generating, at the upgrade package processor, the upgrade package on the basis of differences between a first version and a second version of the program; notifying, at the upgrade package server, the recipient device of an issuance of the upgrade package; downloading, at the recipient device, the upgrade package from the upgrade package server; installing the upgrade package in an upgrade package region of a first memory in which the first version is installed; upgrading the first version to the second version by merging the upgrade package and the first version in response to an upgrade command; and loading the second version in a second memory.

In accordance with another aspect of the present invention, the above and other objects are accomplished by a program upgrade method in a network including an upgrade package processor for generating an upgrade package for a program and an upgrade package server allowing a recipient device to download the upgrade package. The program upgrade method includes comparing, at the upgrade package processor, a first version and a second version the program on a block-by-block basis; generating install data containing map data for mapping blocks of the second version to the first version on the basis of a comparison result; generating the upgrade package by merging the install data and upgrade data; downloading, at the recipient device, the upgrade package; and upgrading the first version installed at the recipient device to the second version by applying the upgrade package to the first version.

In accordance with another aspect of the present invention, the above and other objects are accomplished by a program upgrade system. The program upgrade system includes an upgrade package processor for generating an upgrade package using a first version and a second version of a program; an upgrade package server for storing the upgrade package and advertising issuance of the upgrade package; and at least one recipient device for downloading the upgrade package and upgrading the program using the downloaded package, the recipient device comprising a first memory for separately installing the first version and the upgrade package and a second memory for loading the second version upgraded by merging the first version and the upgrade package.

### BRIEF DESCRIPTION OF THE DRAWINGS

The above and other objects, features and advantages of the present invention will be more apparent from the following detailed description in conjunction with the accompanying drawings, in which:

FIG. 1 is a diagram illustrating a program upgrade system according to an exemplary embodiment of the present invention;

FIG. 2 is a block diagram illustrating an operation of the upgrade package processor 10 of the program upgrade system of FIG. 1;

FIGS. 3A to 3F are diagrams illustrating data formats of upgrade packages generated in the upgrade package processor of FIG. 2;

FIG. 4 is a block diagram illustrating a configuration of an upgrade package processor of a program upgrade system in accordance with an exemplary embodiment of the present invention;

FIG. 5 is a block diagram illustrating a configuration of an upgrade package processor of a program upgrade system in accordance with another exemplary embodiment of the present invention;

FIG. 6A is a diagram illustrating a data format of an upgrade package generated by the upgrade package processor of FIG. 4;

FIG. 6B is a diagram illustrating a data format of an upgrade package generated by the upgrade package processor of FIG. 5;

FIG. 7 is a block diagram illustrating a configuration of an upgrade package processor of a program upgrade system in accordance with another exemplary embodiment of the present invention;

FIG. 8 is a block diagram illustrating a configuration of a recipient device of a program upgrade system according to an exemplary embodiment of the present invention;

FIG. 9 is a block diagram illustrating a configuration of a first memory of a recipient device of FIG. 8;

FIG. 10A is a diagram illustrating a structure of the second storage region of the first memory 250 of FIG. 9;

FIG. 10B is a diagram illustrating a data format of the history data of each upgrade package stored in the second storage region of FIG. 10A;

FIG. 11 is a block diagram illustrating an upgrade operation of a program upgrade system according to an exemplary embodiment of the present invention;

FIG. 12 is a block diagram illustrating an upgrade operation of a program upgrade system according to another exemplary embodiment of the present invention;

FIGS. 13A and 13B are block diagram illustrating an upgrade operation of a program upgrade system according to another exemplary embodiment of the present invention;

FIG. 14 is a block diagram illustrating an upgrade operation of the recipient device of the program upgrade system according to an exemplary embodiment of the present invention;

FIG. 15 is a flowchart illustrating a program upgrade method according to an exemplary embodiment of the present invention;

FIGS. 16A to 16C are flowcharts illustrating an upgrade package generation procedure of a program upgrade method according to an exemplary embodiment of the present invention;

FIG. 17 is a flowchart illustrating an upgrade package generation procedure of a program upgrade method according to an exemplary embodiment of the present invention;

FIG. 18 is a flowchart illustrating a compression reliability test procedure of FIG. 17;

FIG. 19 is a flowchart illustrating an install data generation procedure of FIG. 17;

FIG. 20 is a flowchart illustrating an upgrade package generation procedure of FIG. 17;

FIG. 21 is a message flow diagram illustrating a program download procedure of a program upgrade method according to an exemplary embodiment of the present invention;

FIG. 22 is a flowchart illustrating a downloaded upgrade package processing procedure of a program upgrade method according to an exemplary embodiment of the present invention;

FIG. 23 is a flowchart illustrating an upgrade package install procedure of a program upgrade method according to an exemplary embodiment of the present invention;

FIG. 24 is a flowchart illustrating an upgraded program running procedure of a program upgrade method according to an exemplary embodiment of the present invention; and

FIGS. 25A to 25D are flowcharts illustrating an upgrade program running procedure of a program upgrade method according to another exemplary embodiment of the present invention.

### DETAILED DESCRIPTION OF EXEMPLARY EMBODIMENTS

Exemplary embodiments of the present invention are described with reference to the accompanying drawings in detail. The same reference numbers are used throughout the drawings to refer to the same or like parts. Detailed descriptions of well-known functions and structures incorporated herein may be omitted to avoid obscuring the subject matter of the present invention.

In the following embodiments, a number of the blocks of upgrade versions and a size of a macroblock are defined only to help in the understanding of the present invention. However, it will be obvious to those skilled in the art that the present invention can be implemented without specifically defining the number and size of the macroblocks or modification thereof.

In the following embodiments, an “upgrade” is a process modifying source codes of firmware or software of a system using an upgrade package for fixing bugs and improving usability or performance.

An “upgrade package” is a collection of information on the old and new versions of a target program. “Upgrade data” are modifications to existing codes of the target program. “Install data” are a set of information for updating an old version to a new version of the program. The install data can include history data for indicating a relationship of the upgrade package and the first version, and map data for mapping the blocks of the second version to the first version. The map data can include commands such as “copy”, “shift”, “modify”, etc. for creating a new version of the program, and block location data for executing the commands. A “first version” means an old version of a target program and is interchangeably referred to as a “reference version.” A “second version” is an upgrade version of the first version of the program. The second version of the program can be an upgrade package created on the basis of differences between the first and second versions of the program. A recipient device is installed with the first version of the software during manufacturing stage and can download and store at least one upgrade package when an upgrade event occurs. The upgrade package include install data and upgrade data required for updating the program from the first version to the second version, and particularly, can includes commands “copy”, shift”, and “modify”, and block location data for executing the commands. A “program” can be an operating firmware and application software.

A “first memory” is a memory for storing the first and second versions of the program. A “second memory” is a memory for loading a program upgraded from the first version using the upgrade package represented by the second version. The first and second memories can be implemented with first and second memory regions in a single memory unit or can be implemented as physically separated memory modules. In the following embodiments, the first and second memories are individual memory modules. The first memory is a flash memory as a non-volatile memory, and the second memory is a synchronous dynamic random access memory (SDRAM) as a volatile memory. The first memory stores the first version of the program and at least one upgrade package as the second version of the program. The upgrade package includes history data for identifying versions of the program (including map data) and upgrade data. If an upgrade event occurs by a system initialization or a user command, the system loads the second version of the program upgraded using the upgrade package in the second memory such that the system operates with the second version of the program.

The first version of the program can be the reference version of the program. The second version of the program can be an upgrade package including the install data and upgrade data. The install data can include history data and/or map data. The first version of the program can be an initial version of the program, and the second version of the program includes the upgrade data produced on the basis of the difference between the first and second versions of the program, and install data for installing the upgrade data. The program loaded in the second memory can be a program created by combining the first and second versions of the program.

The program upgrade system can be divided into a transmission system for producing and transmitting upgrade packages and a recipient device for receiving the upgrade packages and upgrading a target program with the upgrade packages.

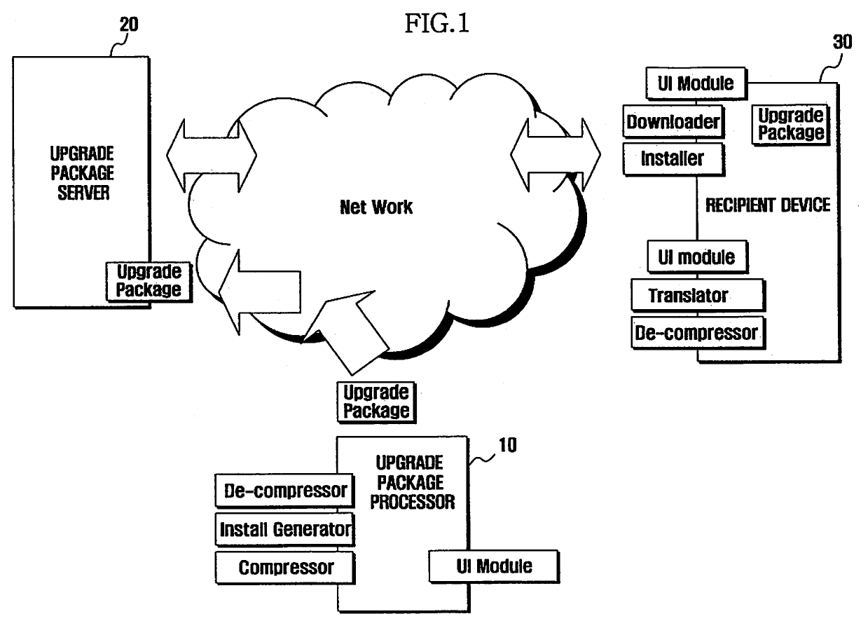

FIG. 1 is a diagram illustrating a program upgrade system according to an exemplary embodiment of the present invention.

Referring to FIG. 1, a program upgrade system includes an upgrade package processor 10, an upgrade package server 20, and a recipient device 30 that communicate with each other through a network.

If a new version (second version) of a program is introduced, the upgrade package processor 10 generates an upgrade package from the old version (first version) and the new version (second version) of the program and then transmits the upgrade package to the upgrade package server 20. Here, the upgrade package processor 10 communicate with the upgrade package server 20 through a wireless channel established on the basis of a wireless communication standard such as Code Division Multiple Access (CDMA), Universal Mobile Telecommunication System (UMTS), Wireless Broadband (WiBro), Wireless Fidelity (Wi-Fi), Worldwide Interoperability for Microwave Access (WiMAX), Bluetooth® (hereinafter “Bluetooth”), and Zigbee, or a wired communication standard such as Universal Serial Bus (USB) and Universal Asynchronous Receiver/Transmitter (UART). The upgrade package server 20 can be integrated into the upgrade package processor 10. If an upgrade package is received from the upgrade package processor 10, the upgrade package server 20 transmits a notification message to a plurality of recipient devices 30 such that the recipient devices download the upgrade package. Also, the upgrade package server 20 and the recipient devices 30 communicate with each other through a wireless channel established on the basis of a wireless communication standard such as CDMA, UMTS, WiBro, Wi-Fi, WiMAX, Bluetooth, and Zigbee, or a wired communication standard such as USB and UART.

If the upgrade package is successfully downloaded, the recipient device 30 stores the upgrade package into a memory unit for producing a second version of the program. The memory unit can be implemented with a first memory and a second memory. The first and second memories can be integrated in a single memory unit, or can be separated from each other. The first memory stores the first version of the program and the upgrade package, and the second memory loads the second version of the program produced from the first version of the program and the upgrade package. That is, the recipient device 30 stores the upgrade package downloaded from the upgrade package server 20 into the first memory as the information for creating the second version of the program. The second version of the program is generated by merging the first version of the program and the upgrade package and then loaded in the second memory, in response to an upgrade command. After the upgrade process, the recipient device 30 operates with the second version of the program loaded on the second memory.

An operation of the upgrade package processor 10 is described hereinafter.

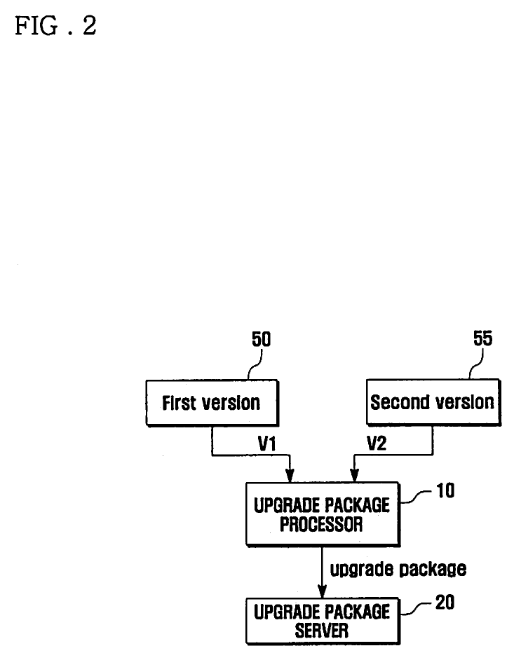

FIG. 2 is a block diagram illustrating an operation of the upgrade package processor 10 of the program upgrade system of FIG. 1.

Referring to FIG. 2, the upgrade package processor 10 receives the first and second versions, 50 and 55, of a program input from outside. The first version 50 of the program can be an original version, and the second version of the program can be one upgraded from the first version of the program. The upgrade package processor 10 generates the upgrade package from the first and second versions of the program. The upgrade package processor 10 compares and first and second versions, 50 and 55, and produces the upgrade package based on the difference between and first and second versions, 50 and 55, and then transmits the upgrade package to the upgrade package server 20. The upgrade package includes upgrade data and install data. The upgrade data is generated in accordance with a difference between and first and second versions of the program, and the install data includes history information and map data. The history data is data to be merged with the second version, and the map data includes commands for copying, changing, and shifting according to a comparison result of the versions, and index information of the commands. The upgrade package can include only the history data and map data. In this case, the modified data is included in the map data rather than in the upgrade data. The upgrade package can be transported to the upgrade package server 20 through a wired or wireless channel.

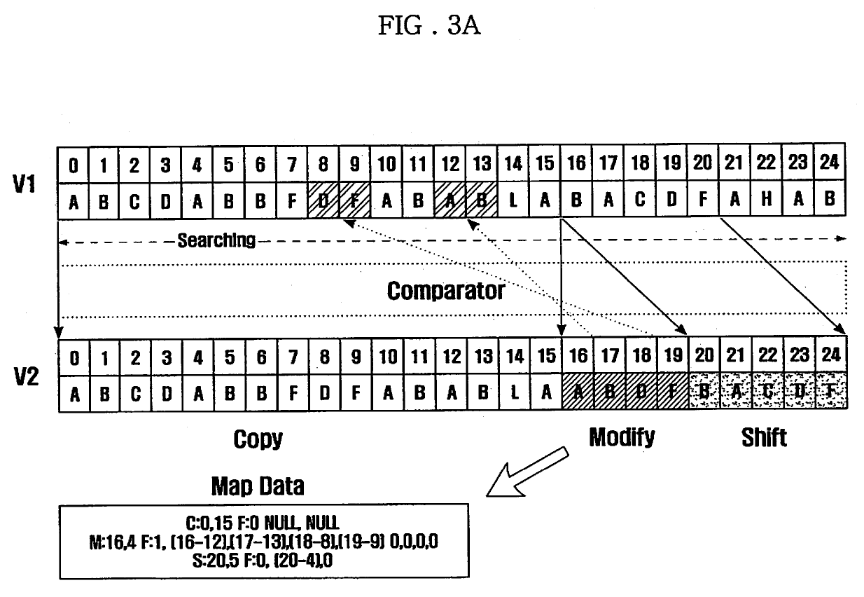

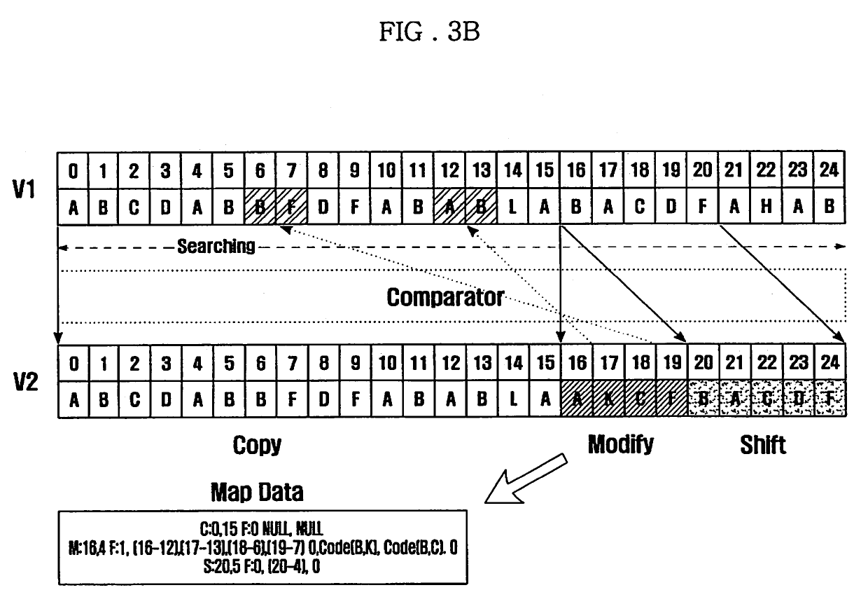

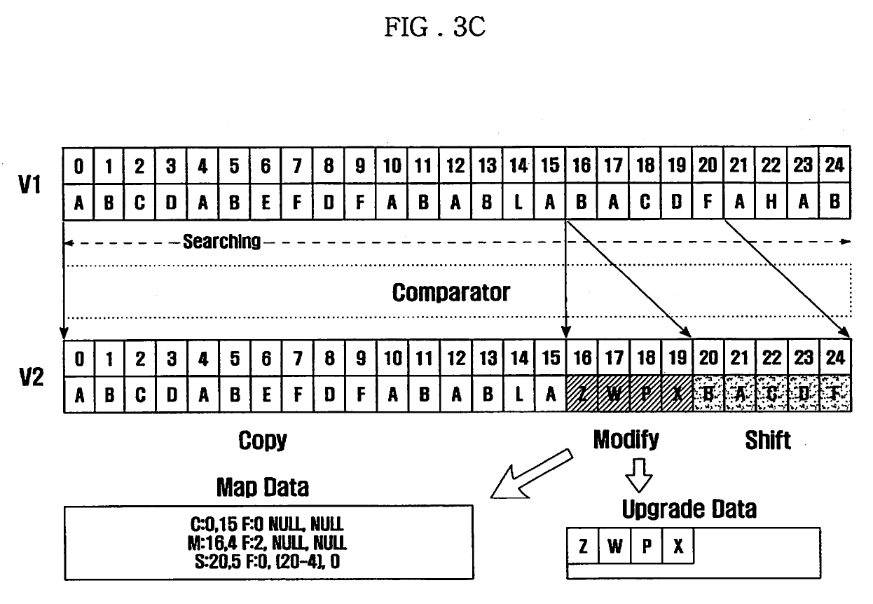

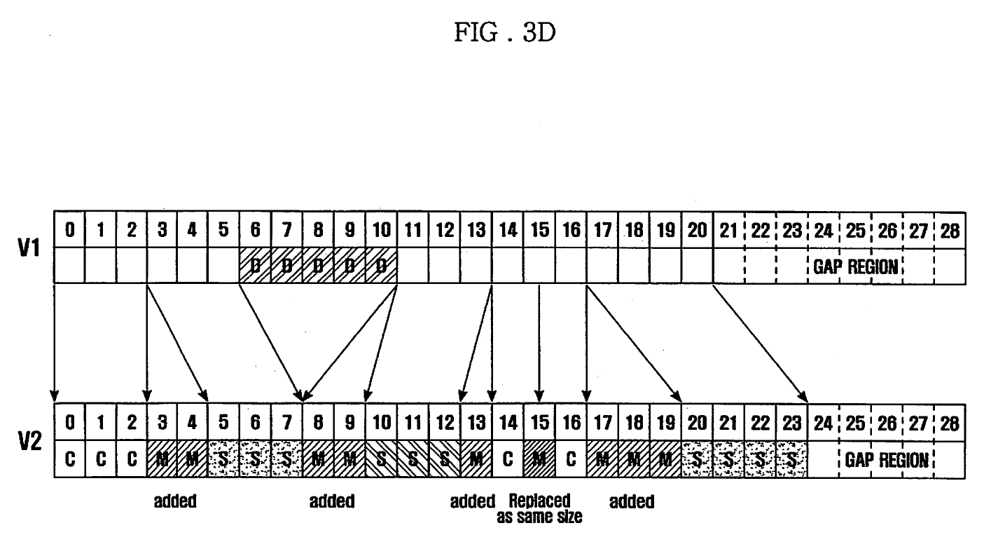

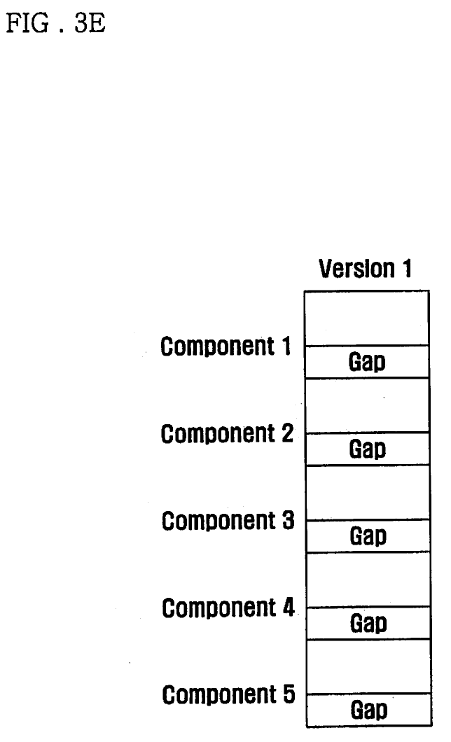

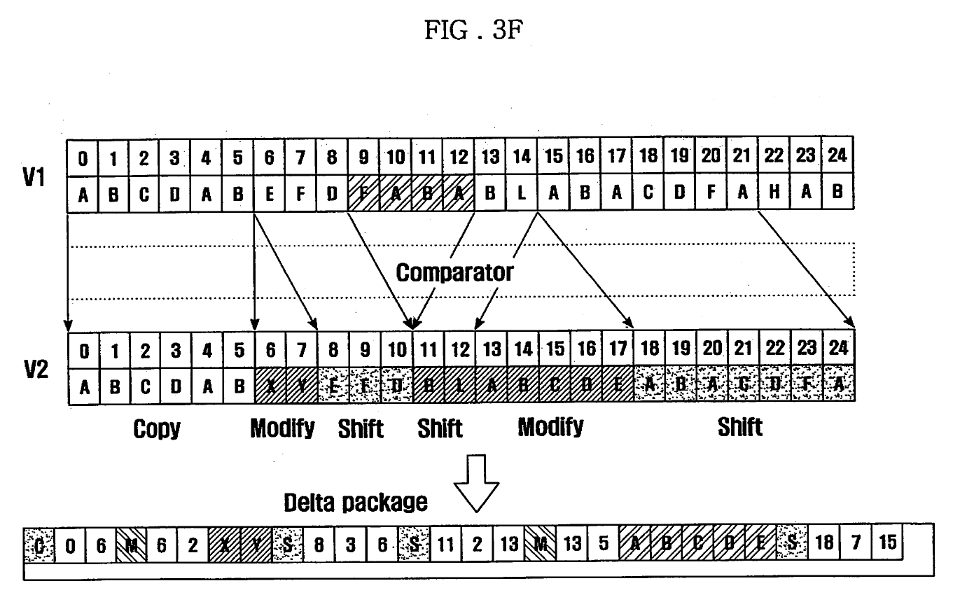

FIGS. 3A to 3F are diagrams illustrating data formats of upgrade packages generated in the upgrade package processor 10 of FIG. 2.

In this embodiment, the upgrade package contains upgrade data, history data, and map data, or contains only the history and map data. Through the description of the present invention, the term “old version” is interchangeably used for referring to a first version (V1), and the term “new version” is for referring to a second version (V2). In the case that the second version (V2) is produced using the first version of the program, a gap region can be assigned for the first version (V1) of the program in order to reduce a shift operation in the upgrade process.

Referring to FIGS. 3A to 3F, the upgrade package processer 10 compares the data of the V1 and V2 on a block-by-block basis having a preset size (this block is herein referred to as a macroblock or MB), retrieves an attribute of each block (copy (C), modify (M), shift (S)), and generates the upgrade package on the basis of the attributes. The upgrade package includes the upgrade data, history data, and map data. In some cases, the upgrade data is not included in the upgrade package. The macroblock is a unit generated by dividing data, and 16 instruction is 16 bits and 32 instruction is 32 bits.

The map data includes command strings starting with a command such as C (copy), M (modify: insert or replace as same size), and S (shift). Each command string is structured in the following command string format:

[Cmd][start block No, number of block][flag][distance][difference] where “Cmd” can be one of C, M, and S, “start block No” denotes a start block number of the corresponding command, and “number of block” denotes a number of the blocks corresponding to the command. “flag” has a value of 0, 1, or 2. The flag is set to 0 when the Cmd is “C” (just copy) or S (just shift), 1 when block data can be generated from V1 (generate data from V1) with the Cmd “M,” and 2 when the block data cannot be generated from V1 but is in delta package (not use V1) with the Cmd “M.” The delta package can be the upgrade data. The “distance” means a block index information indicating a location of a block of V2 in V1.

If a block of V2, of which its data differs from that of a corresponding block of V1, is detected while comparing the V1 and V2, the upgrade package processor 10 tags the block with M for indicating a modified data block. If a modified data block is detected, the upgrade package processor 10 searches a predetermined number of blocks from the block of V1, corresponding to the modified block, in both directions for finding a block having the data of the modified block.

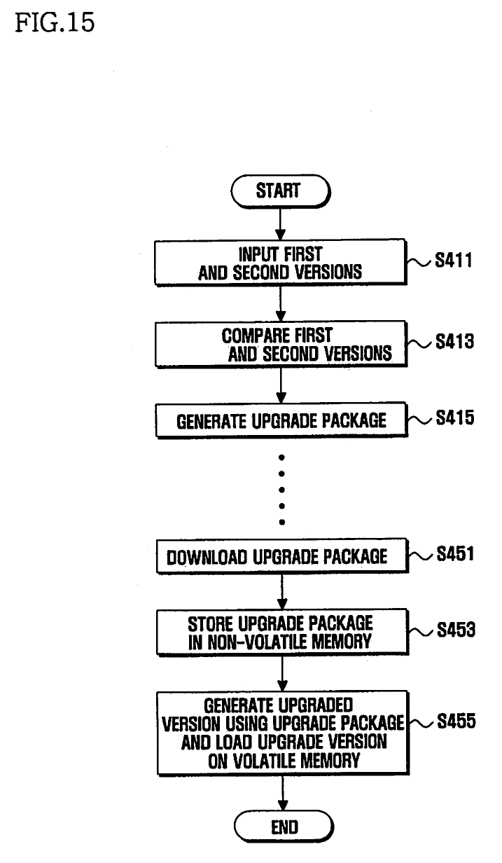

In the examples of FIGS. 3A to 3C, 15 blocks are searched for the blocks in both directions from the modified block. If a block having identical data is found in the search range, the upgrade package processor 10 gathers the index of the block having the identical data. The search range can be set to any number of blocks, for example 2, 4, 8, 16 or 32. In this embodiment, the number of blocks of the search range is 16. The upgrade package processor 10 searches for the 16 blocks in the respective directions from the current block. Accordingly, 32 blocks are compared with the block of the second version. In FIGS. 3A to 3C, four blocks 16 to 19 of the V2 are modified in comparison with the V1, are found as the blocks having the data identical with those of the modified data. Accordingly, the upgrade package processor 10 generates the upgrade package with the map data containing the indexes of the blocks 6, 7, 12, and 13 rather than packing the modified data themselves.

The map data of the modified blocks are generated by comparing in unit of block or a set of blocks. Typically, the modified data of the second version can be generated as a plurality of blocks. That is, when the program is upgraded to a new version, the upgraded program (V2) can be generated by inserting and or replacing the data in the form of the modified blocks. In this case, the modified block data can be identical with or similar to the block data of the reference program (V1). In this embodiment, the map data is generated by comparing in a unit of a set of blocks when searching the modified blocks. In this case, the number of blocks included in the set can be 2, 4, 8, 16, etc. The number of blocks is set to a multiple of 2 for increasing computation speed. The blocks of the second version (V2) are compared with the blocks of the first version (V1). If the blocks are copied or shifted blocks, the indexes of the blocks are included in the map data. If the blocks are modified blocks, the upgrade package processor 10 compares the block data, determines the command for the blocks of the second version as “modify”, and generates the map data with the indexes of the blocks. In the case of a 2-block search, the search starts at the block indexes of 0, 2, 4, 6, etc. In the case of a 4-block search, the search starts at the block indexes of 0, 4, 8, . . . In the case a of 8-block search, the search starts at the block indexes of 0, 8, 16, . . . This is for reducing the calculation complexity of the upgrade package processor 10.

In FIGS. 3A to 3C, the search range is set to 32 blocks (16 blocks in both directions) and the modified block search is performed in a unit of multiple blocks. FIG. 3A shows an example that the blocks identical with the modified blocks of the second version (V2) exist in the search range of the first version (V1). FIG. 3B shows an example that the blocks similar to the modified blocks of the second version (V2) exist in the search range of the first version (V1). FIG. 3C shows an example that no blocks identical with or similar to the modified blocks of the second version (V2) exist in the search range of the first version (V1).

In the case where the blocks identical with the modified blocks of the V2 are found in the search range of the V1, the upgrade package processor 10 generates map data having the information on the indexes of the blocks.

As shown in FIG. 3A. the upgrade package processor 10 compares the V1 and V2 in unit of block. If at least one modified block is detected, the upgrade package processor 10 searches for an identical block in the search range of the V1. If an identical block is found, the upgrade package processor 10 produces the map data containing the index of the block of the V1 rather than generating the upgrade data of the modified block of the V2.

In the example of FIG. 3A, the 16^{th} to 19^{th} blocks of the V1 are right-shifted so as to occupy the 20^{th} to 24^{th} blocks of the V2. Accordingly, the upgrade package processor 10 searches for the blocks identical with the modified 16^{th} to 19^{th} blocks of the V2 and detects that the 12^{th}, 13^{th}, 8^{th}, and 9^{th} blocks of the V1 are identical with the modified 16^{th} to 19^{th} blocks. As shown in FIG. 3A, the 16^{th} and 17^{th} blocks of the V2 are identical with the 12^{th} and 13^{th} blocks of the V1, and the 18^{th} and 19^{th} blocks of V1 are identical with the 8^{th} and 9^{th} blocks. Table 1 shows map data to be contained in the upgrade package generated in such manner depicted in FIG. 3A.

TABLE 1

C: 0, 15, F: 0, null, null
M: 16, 4 F: 1, (16-12), (17-13), (18-8), (19-9), 0, 0, 0, 0
S: 20, 5 F: 0, (20-4), 0
OR
C: 0, 15, F: 0, null, null
M: 16, 4 F: 1, (16-12), (17-13), (18-8), (19-9), 0, 0, 0, 0
S: 20, 5 F: 0, (20-16), 0

In Table 1, the map data inform that the 0^{th} to 15^{th} blocks of the V2 are identical with those of the V1, the 16^{th} to 19^{th} blocks of V2 are identical with 12^{th}, 13^{th}, 8^{th}, and 9^{th} blocks of V1, and the 20^{th} to 24^{th} blocks of the V2 are identical with the 16^{th} to 20^{th} blocks of V1. That is, when the modified blocks of the V2 are found in the search range of the V1, the upgrade package processor 10 generates the map data mapping the modified blocks of the V2 to the blocks found in the search range of the V1. In this case, the upgrade package is generated with the history data and the map data shown in Table 1.

FIG. 3B shows another example of the upgrade package generation technique when blocks identical with some modified blocks of the V2 do not exist but similar blocks exist in the search range of the V1. As shown in FIG. 3B, the 16^{th} to 19^{th} blocks of V2 are newly inserted and the original 16^{th} to 19^{th} blocks of V1 are right-shifted to become the 20^{th} to 24^{th} blocks of the V2.

As shown in FIG. 3B, there is no blocks identical with the 17^{th} and 18^{th} blocks of the V2 in the search range of the V1. In this case, the upgrade package processor 10 generates the map data shown in Table 2 using the data of the V1 and V2.

TABLE 2
C: 0, 15, F: 0, null, null
M: 16, 4 F: 1, (16-12), (17-13), (18-6), (19-7), 0, code (B, K), code
(B, C), 0
S: 20, 5 F: 0, (20-4), 0

In Table 2, the map data inform that the 0^{th} to 15^{th} blocks of the V2 are identical with those of the V1 and the 20^{th} to 24^{th} blocks of the V2 are identical with the 16^{th} to 20^{th} blocks of the V1. Also, the map data inform that the 16^{th} and 19^{th} blocks of V2 are identical with 12^{th} and 7^{th}, the 17^{th} block of the V2 is entropy-encoded (code (B,K)) by a difference with the 13^{th} block of the V1, and the 18^{th} block of the V2 is entropy-encoded (code (B,C)) by a difference with the 8^{th} block of the V1. In the case that a block identical with the modified block of the V2 is not found in the search range of the V1 as in FIG. 3D, the upgrade package processor 10 maps the modified blocks of the V2 to corresponding blocks of the V1 and performs entropy coding on the basis of the difference of the blocks of the V1 and V2.

FIG. 3C shows another example of the upgrade package generation technique when blocks identical with or similar to some modified blocks of the V2 do not exist in the search range of the V1.

The upgrade package processor 10 compares the V1 and V2 in unit of block, checks the attributes (C, M, or S) of the blocks of the V2, and generates the upgrade data on the basis of the attributes of the blocks. The data of modified blocks are packed into the upgrade package. As described above, the upgrade package processor 10 checks if a block identical with a modified block of the V2 exists in the search range of the V1. If no identical block is found, the upgrade package processor 10 performs the entropy coding with the difference of the blocks of the V1 and V2 to generate upgrade data.

In FIG. 3C, the 16^{th} to 19^{th} blocks of V2 are inserted in comparison such that the 16^{th} to 19^{th} blocks of the V1 are right-shifted. The upgrade package processor 10 searches for blocks identical with the newly inserted blocks of the V2 in the search range of the V1. Since there are no identical blocks in the search range, the upgrade package processor 10 designates the attribute M to the inserted blocks and sets the blocks as the upgrade data.

As shown in FIG. 3C, there are no blocks identical with the 16^{th} to 19^{th} blocks of the V2 in the search range of the V1. In this case the upgrade package processor 10 generates the map data as shown in Table 3 and the upgrade data using the entropy coding.

TABLE 3

C: 0, 15, F: 0, null, null
M: 16, 4 F: 2, null, null
S: 20, 5, F: 0, (20-4), 0

In table 3, the map data inform that 0^{th} to 15^{th} blocks of the V2 are identical with those of the V1, the 20^{th} to 24^{th} blocks of V2 are identical with the 16^{th} to 20^{th} blocks of the V1, and the 16^{th} to 19^{th} blocks of V2 are entropy-coded into Z, W, P, and X (code (E, C)). When a modified block is not found in the search range as in FIG. 3C, the upgrade package processor 10 sets the flag of the block to 2 (F=2) and generates separate upgrade data. In this case, the upgrade package includes the history data, map data, and upgrade data.

In the case of FIG. 3C, the upgrade package processor 10 also can generate the upgrade package without additional upgrade data. Table 4 shows the map data when the upgrade data are excluded from the upgrade package.

TABLE 4

C: 0, 15, F: 0, null, null
M: 16, 4 F: 2, null, Z, W, P, X
S: 20, 5, F: 0, (20-4), 0

In the case that the modified blocks are not found in the search range of the V1 (see FIG. 3C), the upgrade package processor produces map data by entropy-encoding the data of the modified blocks. If the map data is generated in the form of Table 4, the upgrade package processor 10 does not produce additional upgrade data and generates the upgrade package with the history data and the map data.

FIG. 3D shows an example of an improved upgrade package generation technique by providing a gap region in the V1, and FIG. 3E shows an example of an upgrade package generation technique especially when a block of the V1 is removed from the V2.

Referring to FIG. 3D, if new data is added or some data is removed in the V2 in comparison with the V1, the upgrade package processor 10 shifts the blocks following the add or removed blocks. If the blocks are left-shifted, the upgrade package processor 10 searches for the block identical with each modified block in the search range of the V1. If an identical block is found, the upgrade package processor 10 maps the block index of the V1 to the modified block of V2. Conversely, if no identical macroblock is found, the upgrade package processor 10 performs entropy coding on the modified block data of the V2 to generate upgrade data.

While updating the V1 to the V2, a plurality of shift operations may be performed. The V1 can be programmed with a gap region reserved for the shift operations. The gap region can be configured in consideration of the upgrade data for the V2. Preferably, the shift operations are performed without affecting a next component using the gap region as shown in FIG. 3D. In the example of FIG. 3D, the V2 is programmed by removing the 6^{th} to 10^{th} blocks of the V1, adding the 3^{rd}, 4^{th}, 8^{th}, 9^{th}, 13^{th} and 17^{th} to 19^{th} blocks to the V1, and replacing the 15^{th} block. In this case, the 5 blocks are deleted and 8 blocks are added such that last 3 blocks are shifted. Since the last 3 blocks are shifted to the gap region, the next component of the V2 can be compared with the corresponding component of V1 without affect of the shift operations.

Referring to FIG. 3E, the Firmware Over-The-Air (FOTA)-capable binary data is provided with gap regions such that the components are protected from each other. The program has the structure of FIG. 3E. That is, the V1 is composed by a plurality of components (in FIG. 3E, 5 components), and each component has a gap region. When the V2 is introduced as an upgraded program of the V1 with additional data blocks, the upgrade package processor 10 can perform shift operations with the gap region. That is, the upgrade package processor 10 performs the upgrade process in a unit of a component such that the upgrade package can be generated per component.

As described above, the upgrade package is generated with the history data, map data, and upgrade data. In this case, the map data includes the attributes (copy, modify, and shift) of the blocks with block indexes, and the upgrade data represents the modified blocks. Also, the upgrade package can be generated with the map data and history data but not the upgrade data. In this case, the map data can include the information on the modified blocks in addition to the attributes of the blocks and their indexes.

FIG. 3F shows an example of the upgrade package generation technique using the history data and the upgrade data. In the case of generating the upgrade package with the history data and the upgrade data, the upgrade package processor 10 generates upgrade data as shown in FIG. 3F without the production of map data. Here, the upgrade data has a structure containing the block data together with block indexes of the V2.

Referring to FIG. 3F, the V2 is programmed by adding new 6^{th} and 7^{th} blocks between the 5^{th} and 6^{th} blocks of the V1, adding new 13^{th} to 17^{th} blocks between the 14^{th} and 15^{th} blocks of the V1, and removing the 9^{th} to 12^{th} blocks of the V1. In this case, the upgrade package processor 10 incorporates the block indexes and information on the block data into the upgrade package. The upgrade data has a structure similar to that of the map data. That is, the upgrade data include the command strings starting with one of command of a C (copy), M (modify, insert or replace as same size), and S (shift), and structured in the following string formats.

Copy command string

[cmd][start block No][number of block]

Modify command string

[cmd][start block No][number of block][data]

Shift command string

[cmd][start block No][number of block][previous version position]

The copy command string includes a start block index and a number of the blocks to be copied; the modify command string includes a start block index and concatenation information of the blocks; and the shift command string includes a start block index and a corresponding block index of the V1.

In the example of FIG. 3F, the upgrade information for indicating the blocks to be copied to the V2 can be expressed by “C:0,6”: the upgrade information for indicating the blocks to be modified can be expressed by “M:6,2,X,Y” and “M:13,5, A,B,C,D,E”; and the upgrade inform for indicating the blocks to be shifted can be expressed by “S:8,3,6, S:11,2,13” and “S:18,7,15.”

In the case that the upgrade package is generated as shown in FIG. 3F, the recipient device receive the upgrade package copies the 0^{th} to 5^{th} blocks of the V2 from the V1, adds the X and Y for the 6^{th} and 7^{th} blocks, shifts the 6^{th} to 8^{th} blocks of the V1 for 8^{th} to 10^{th} blocks of the V2, discards the 9^{th} to 12^{th} blocks of the V1, shifts the 13^{th} and 14^{th} blocks of the V1 for the 11^{th} and 12^{th} blocks of the V2, adds the A, B, C, D, and E for the 13^{th} to 17^{th} blocks of the V2, and shifts the 15^{th} to 21^{st} blocks of the V1 for 18^{th} to 24^{th} blocks of the V2. The upgrade data of the upgrade package (delta package) generated by the upgrade package processor 10 can be expressed as Table 5.

TABLE 5

C: 0, 6
M: 6, 2, X, Y
S: 8, 3, 6
S: 11, 2, 13
M: 13, 5, A, B, C, D, E
S: 18, 7, 15

The upgrade package processor 10 generates the upgrade package by combining the upgrade data and the history data and transports the upgrade package to the upgrade package server 20. At this time, the upgrade package generated by the upgrade package processor 10 is compressed before the upgrade package server 20. By generating the upgrade package using the upgrade data without map data, the upgrade package generation speed can be improved. The upgrade package can be generated without the compression process.

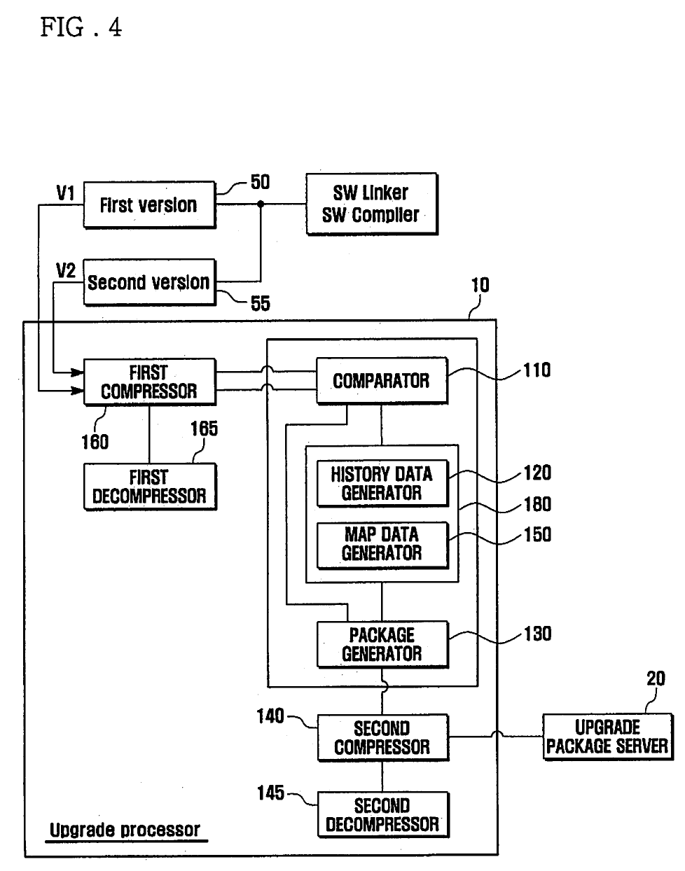

The upgrade package generation techniques are described with reference to FIGS. 4 to 7 in more detail when using the history data, map data, and upgrade data and using the history data and upgrade data.

FIG. 4 is a block diagram illustrating a configuration of an upgrade package processor of a program upgrade system in accordance with an exemplary embodiment of the present invention. The upgrade package processor 10 compresses the V1 and V2, produces an upgrade data and map data through a comparison analysis, generates an upgrade package by combining an install data including the map data and the upgrade data.

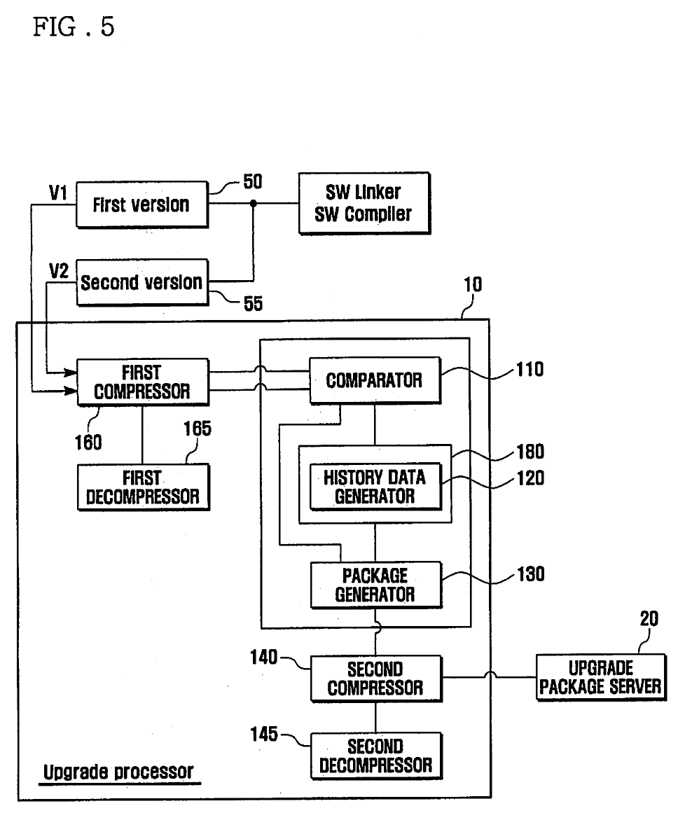

FIG. 5 is a block diagram illustrating a configuration of an upgrade package processor of a program upgrade system in accordance with another exemplary embodiment of the present invention. The upgrade package processor 10 compresses the V1 and V2, produces upgrade data, and generates an upgrade package by combining install data and the upgrade data. In this embodiment, the install data does not include map data.

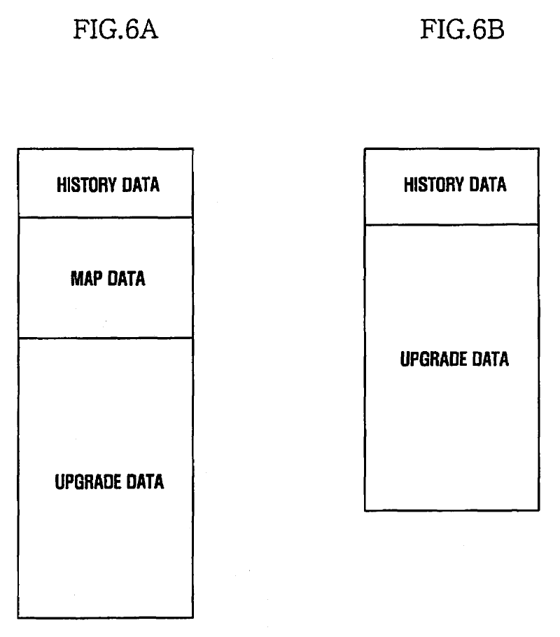

FIG. 6A is a diagram illustrating a data format of an upgrade package generated by the upgrade package processor of FIG. 4, and FIG. 6B is a diagram illustrating a data format of an upgrade package generated by the upgrade package processor of FIG. 5.

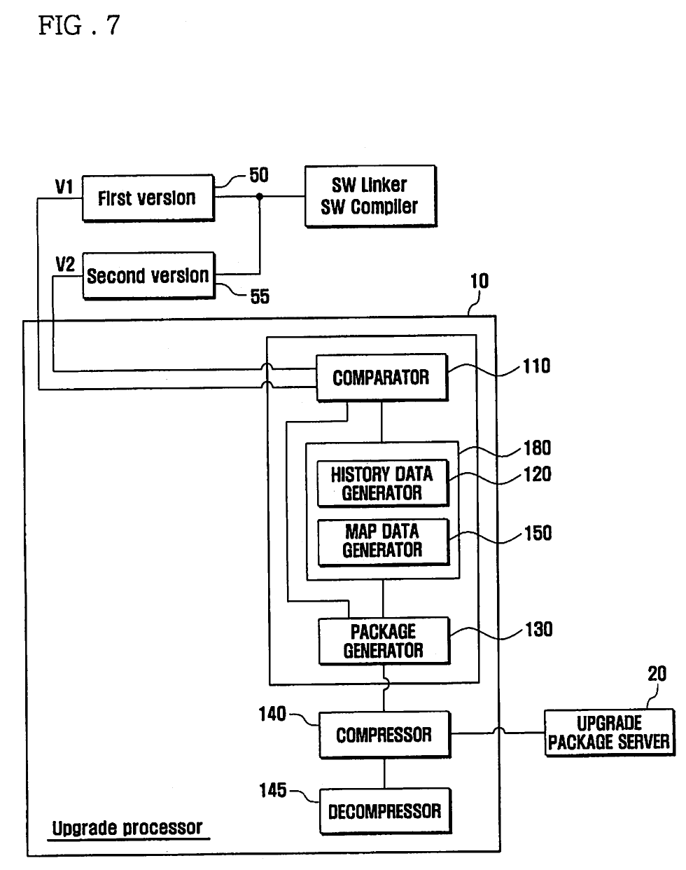

FIG. 7 is a block diagram illustrating a configuration of an upgrade package processor of a program upgrade system in accordance with another exemplary embodiment of the present invention. The upgrade package processor 10 compares raw data of the V1 and V2 to produce an upgrade data through the comparison analysis, and generates an upgrade package by combining install data including map data and the upgrade data. In this case, the install data can be generated without map data.

Referring to FIGS. 4 to 6B, the upgrade package processor 10 includes a first compressor 160, a first decompressor 165, a comparator 110, an install data generator 180 including a history data generator 120 and a map data generator 150, a package generator 130, a second compressor 140, and a second decompressor 145. A first version (V1) 50 and the second version (V2) 55 of a program are input after being compressed as shown in FIGS. 4 and 5 or input in the form of raw data without the compression process as shown in FIG. 7. The comparator 110 compares the V1 and V2 in unit of block and checks to determine if corresponding blocks of the V1 and V2 are identical with each other. The comparator 110 can use an exclusive OR operation circuit. If the compared blocks are not identical with each other, the comparator 110 searches for a block identical with the corresponding block of the V2 in a search range of the V1. If a block identical with the corresponding block of the V2 is found in the search range of the V1, the comparator 110 delivers information on the comparison result and the block index of the block found for the corresponding block of the V2 to the install data generator 180.

That is, the comparator 110 compares the blocks of the V1 and V2 having the same block index and, if the two blocks having the same block index are identical with each other, delivers the comparison result with identity information. Conversely, if the two blocks are not identical with each other, the comparator 110 searches for the block identical with the current block of the V2 in the search range of the V1. The search range is defined by a number of the blocks from a target block in regressive and progressive directions of the compression process (in the examples of FIGS. 3A to 3F, a total 30 blocks, 15 blocks in each of the regressive and progressive directions). The search can be performed by swinging the target block of the V2 in the search range of the V1. If an identical block is found in the search range of the V1, the comparator 110 delivers the comparison result with a block index of identical block to the install data generator 180. If no identical block is found, the comparator 110 delivers the comparison result with a block index of a neighbor block in the V1 (in the case of modified block, a block index of the block next to the copied or shifted block) to the install data generator 180.

Returning to FIGS. 3A to 3C, if the 0^{th} to 15^{th} blocks of the V2 are compared with corresponding blocks of V1, the comparator 110 delivers the comparison results with their identities to the install data generator 180.

In the case of 16^{th} to 19^{th} blocks of the V2, the comparator 110 recognizes that the blocks are not identical with those of the V1 so as to search for the blocks identical with respective target blocks of the V2 in the search range of the V1. If the search range is 15 blocks, the comparator 110 searches the 1^{st} to 15^{th} blocks and then searches again the 17^{th} to 31^{st} blocks of the V1. In the case of FIG. 3A, the comparator 110 recognizes that the 16^{th} to 19^{th} blocks of the V2 are identical with the 12^{th}, 13^{th}, 8^{th}, and 9^{th} blocks of the V1, respectively. Accordingly, the comparator 110 delivers the comparison result having the block indexes of the 16^{th} to 19^{th} blocks of the V2 and the block indexes of the 12^{th}, 13^{th}, 8^{th}, and 9^{th} blocks of the V1 with their relationships to the install data generator 180.

In the case of FIG. 3B, the comparator 110 recognizes that the 16^{th} to 19^{th} blocks of the V2 are similar to 12^{th}, 13^{th}, 6^{th}, and 7^{th} blocks of the V1 such that the comparator 110 delivers a comparison result having the block indexes of the 16^{th} to 19^{th} blocks of the V2 and the block indexes of the 12^{th}, 13^{th}, 6^{th}, and 7^{th} blocks of the V1 with their relationships to the install generator 180. At this time, the comparison result informs a difference between data K of the 17^{th} block of the V2 and data B of the 13^{th} block of the V1, and a difference between data C of the 18^{th} block of the V2 and the data B of the 6^{th} block of the V1. That is, when a prior block of two sequential blocks of the V2 is identical with a prior block of two sequential blocks of the V1 but a posterior block of the two sequential blocks of the V2 is not identical with a posterior block of the two sequential blocks of the V1, the comparator 110 delivers the comparison result having block indexes with their relationships.

In the case of FIG. 3C where the blocks identical to or a series of blocks similar to the 16^{th} to 19^{th} blocks of the V2 are not found in the search range of the V1, the comparator 110 delivers the comparison result indicating that the 16^{th} to 19^{th} blocks of the V2 cannot be derived from the V1.

The install data generator 180 can be implemented with the history data generator 120 and the map data generator 120 as shown in FIG. 4, or can be implemented only with the history data generator 120 as shown in FIG. 5. The history data generator 120 stores a version number of the second version of the program. For example, the version number stored in the history data generator 120 is 5, the version of the second program V2 is 5 such that the first version V1 is upgraded by combining with the second version V2 having a version number of 5. The map data generator 150 produces map data for generating the upgrade package by analyzing the comparison result having blocks indexes of the first and second versions. The map data is produced in the format of [Cmd][start block No, number of block][flag][distance][difference]. If the blocks of the first and second versions having the same block indexes are identical with each other, the map data generator 150 sets the command field of the map data to C and lists the block indexes. The operation is repeated until a modified block or a deleted block is detected in the second version.

If the blocks having the same block index differ from each other, the map data generator 150 sets the command field of the map data to M or S. The command M can imply an insertion command or a replacement command. The map data generator 150 analyzes the comparison result in association with the block indexes. If it is determined that the second version V2 includes additional blocks in comparison with the first version V1, the map data generator 150 sets the command field to M of the map data. After setting the command field to M, the map data generator 150 searches for the blocks identical with the added blocks in the search range of the V1. The map data generator 150 generates a modification map data depending on whether the identical blocks are found as in the example of FIG. 3A, similar block patterns are found as in the example of FIG. 3B, or no identical blocks and no similar block patterns are found as in the example of FIG. 3C, in the search range of the V1. In the case of FIG. 3C, the map data and upgrade data are separately generated as in Table 3, or the upgrade data can be incorporated into the map data as in Table 4. In the following embodiment, how to generate the map data and upgrade data are separately described.

When a modified block replaces the original block of the same size, the map data generator 150 performs an entropy coding on the basis of the difference between the two blocks and generates the map data with the entropy coding result. In this case, the blocks following the replaced block are not shifted. When some blocks of the first version V1 are removed in the second version V2, the map data generator 150 generates map data for shifting the blocks following the removed block such that the empty spaces are filled by the shifted blocks.

If the modified blocks are inserted, the original blocks are right-shifted. After generating the insertion map data for inserting the modified blocks, the map data generator 150 analyzes the output of the comparator 110, i.e. the block indexes of the first and second versions. Next, the map data generator 150 generates the map data incorporating the block indexes, a number of the blocks to be shifted, and numbers of shift blocks of the first and second versions.

If the second version shown in FIG. 3A is introduced, the map data generator 150 generates the map data as shown in Table 1. If the second version shown in FIG. 3B is introduced, the map data generator 150 generates the map data as shown in Table 2. If the second version shown in FIG. 3C is introduced, the map data generator 150 generates the map data as shown in Table 3 or 4. In the following description, the map data generation is described with an example of FIG. 3C and Table 3.

The package generator 130 analyzes the compressed block data of the second version output from the first compressor 160 and the map data output from the map data generator 150 and generates an upgrade package on the basis of the analysis result. The package generator 130 determines whether to generate the upgrade data on the basis of the map data received from the map data generator 150. In more detail, the package generator 130 analyzes the command field of the map data. The package generator 130 does not generate upgrade data if the command field of the map data of a block is set to C or S. If the map data contains data for the corresponding block or a block index for indexing a block of the first version, even though the command field of the map data is set to M, the package generator 130 does not generate upgrade data. Conversely, if the map data has the command field set to M but not a block index of the first version or entropy data, the package generator 130 produces upgrade data using compressed block data of the second version. That is, package generator 130 does not generate data if the flag is set to F=1 although the command field is set to M, but generates data when the command field is set to M and the flag is set to 2.

Next, the package generator 130 generates an upgrade package by merging the upgrade data, if it is provided, and the install data generated by the install data generator 180. The install data can be composed of only the history data or the history data and the map data. That is, the install data generator 180 can be implemented with the history data generator 120 and the map data generator 150 as depicted in FIG. 4, or with only the history data generator 120 as depicted in FIG. 5.

Referring to FIG. 5, the install data generator 180 is implemented without the map data generator 150 unlike in FIG. 4. In this case, the package generator 130 generates the upgrade data including the block indexes of the first version mapped to the corresponding block indexes of the second version and information on the block data. At this time, the upgrade data is provided with commands similar to those provided by the map data generator 150 of FIG. 4. The upgrade data per block can be expressed in such a format as C:[start block No][number of block], M:[start block No][number of block][data], and S:[start block No][number of block][previous version position]. That is, the upgrade data for copying a block from the V1 includes a start block index and a number of the blocks to be copied; the upgrade data for adding or modifying blocks of the V1 includes a start block index, a number of the blocks to be inserted or modified, and concatenated block data for the blocks to be inserted or modified; and the upgrade data for shifting blocks of the V1 includes a number of the blocks to be shifted and a block index of a first block to be shifted.

Next, the package generator 130 generates an upgrade package by merging the upgrade data and the history data and transmits the upgrade package to the upgrade package server 20. The upgrade package can be compressed by the second compressor 140 before being transmitted to the upgrade package server 20. In the case that the upgrade package is generated without map data, the upgrade package can be quickly generated.

As described above, the upgrade package can be composed of the history data, map data, and upgrade data, or composed of only the history data and the upgrade data. FIG. 6A shows a data format of an upgrade package generated by the upgrade package processor of FIG. 4, and FIG. 6B show a data format of an upgrade package generated by the upgrade package processor of FIG. 5.

The upgrade package output from the package generator 130 is compressed by the second compressor 140 and the compressed upgrade package is transmitted to the upgrade package server 20. The second compressor 140 may not be used. However, it is prefer to compress the upgrade package for improving the transmission efficiency. In the case that the first and second versions of the programs are compressed by the first compressor 160, the first decompressor 165 decompresses the compressed first and second versions for testing if the compression on the first and second versions were correctly performed. If it is determined that an error occurred while compressing the first and second versions, the first compressor 160 is controlled to retry the compression.

The upgrade package processor 10 is structured such that the first and second versions of the program are compared in the forms of compressed program data in FIGS. 4 and 5. In this case, the comparator 110 compares the compressed first and second versions of the program. However, the comparator 110 can be configured to compare the raw data of the first and second versions.

FIG. 7 is a block diagram illustrating a configuration of an upgrade package processor of a program upgrade system in accordance with another exemplary embodiment of the present invention. As shown in FIG. 7, the upgrade package processor 10 is implemented without the first compressor unlike the upgrade package processors in FIGS. 4 and 5. Accordingly, the comparator 110 divides the first and second versions of the program into blocks and compares the data of the first and second versions of the program in a unit of a block. The structure and operation of the upgrade package processor of FIG. 7 are identical with that of FIG. 4 except that the upgrade package processor of FIG. 7 has no first compressor. Although the install data generator 180 includes the history data generator 120 and map data generator, the install data generator 180 can implemented only with the history data generator 120 as in the upgrade package generator of FIG. 5.

As described above, the upgrade package processor 10 compares the data of the second version to the corresponding data of the first version and generates an upgrade package with or without the install data depending on the comparison result. If the second version is programmed such that some data blocks are removed from or added to the first version, the original data blocks are shifted. In the case that some blocks are removed, the blocks following the removed blocks are left-shifted. In contrast, if some blocks are added, the blocks occupied positions at which the new blocks are added are right-shifted. When the second version includes modified blocks, the upgrade package processor 10 searches for blocks identical with the modified blocks in a search range of the first version, and matches the block indexes of searched blocks in the V1 to the block indexes of the modified blocks in the V2 or performs entropy coding on the basis of the similarities of some series of the blocks, depending on the search result. The blocks of the V1 replaced by the modified blocks are right-shifted in the V2 as much as the number of the modified blocks. The upgrade package processor 10 produces map data having a command filed set to C (copy), M (modify), and S (shift) on the basis of the comparison result, and generates an upgrade package composed of the map data, history data, and upgrade data. The map data can be incorporated into the upgrade data. The upgrade package is transmitted to the upgrade package server 20 through a wired or wireless communication channel.

If an upgrade package is received from the upgrade package processor 10, the upgrade package server 20 notifies the recipient devices 30 of an issuance of a new upgrade package such that the recipients 30 can download the upgrade package from the upgrade package server 20. The upgrade package server may include a notification server for notifying the issuance of new upgrade package.

If an upgrade notification message is received from the upgrade package server 20, the recipient device 30 triggers a download of the upgrade package by responding to the upgrade notification message.

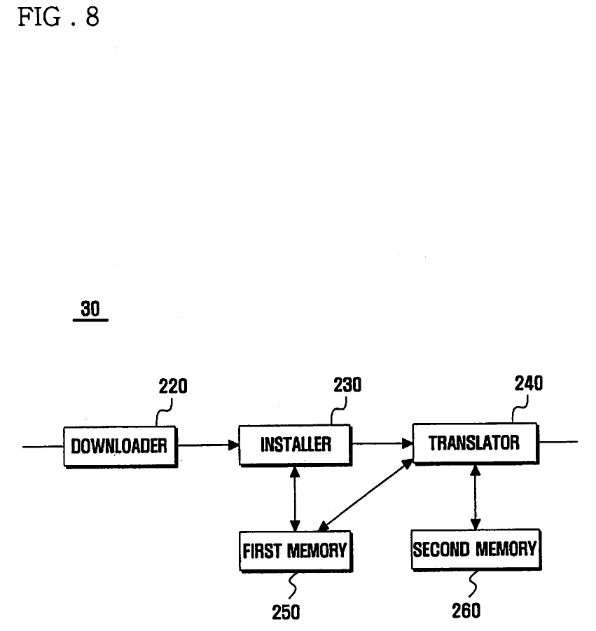

FIG. 8 is a block diagram illustrating a configuration of a recipient device of a program upgrade system according to an exemplary embodiment of the present invention.

Referring to FIG. 8, the recipient device 30 includes a downloader 220, an installer 230, a translator 240, a first memory 250, and a second memory 260.

The downloader 220 receives the upgrade package downloaded from the upgrade package server 20, the installer 230 extracts install data and upgrade data and stores the extracted install data and upgrade data into the first memory 250. The install data are composed of history data and map data. However, the install data may include only the history data. In the case that the install data has no map data, block mapping information can be contained in the upgrade data. If the install data having no map data is received, the installer 230 performs a comparison analysis on the first version and the upgrade data and determines whether to generate map data depending on the analysis result. In the case where no map data is generated by the installer 230, the translator 240 can merge the upgrade package and the first version of the program using the mapping information contained in the upgrade data. The installer 230 stores the history data, map data, and upgrade data within a region of the first memory 250 prepared for the upgrade package. The first memory 250 can store the first version of the program and at least one upgrade package for updating the first version to the second version of the program. A number N of the upgrade packages that can be stored in the first memory 250 can be preset. In this embodiment, N is set to 6.

If an upgrade package for a new version of the program is downloaded, the recipient device 30 outputs an alert for notifying the user that a program upgrade is prepared. At this time, the translator 240 reads out the data of the first version of the program and the upgrade package for the second version, and merges the data of the first version and the upgrade package so as to produces the second version. The second version of the program is loaded on the second memory 260. At this time, the translator 240 analyzes the install data of the upgrade package to check the version number and the target version to be upgraded. Also, the translator 240 analyses the map data and upgrades the data of the blocks of the target version (in this embodiment, the first version) with corresponding upgrade data with reference to the map data. In the case where the install data has no map data, the translator 240 analyzes the history data and determines a target version of the program to be upgraded on the basis of the history data analysis result. The second version can be generated by merging the upgrade data of the upgrade package and the first version. The translator 240 loads the data of the second version on the second memory 260 while the first version is upgraded to the second version. After completing the upgrade process, the recipient device 30 operates with the second version of the program loaded on the second memory 260.

As described above, the first memory 250 stores the first version of the program and at least one upgrade package for updating the first version to the second version. The upgrade package includes install data (history and map data) and upgrade data. The install data can be composed of only history data. Also, the upgrade package can be composed of only the install data. The install data is composed of the map data containing mapping information of the history data and the upgrade data of the upgrade package. The map data provides a relationship between the two versions by using the 3 types of commands i.e. copy, modify, and shift. The map data is used for a quick address calculation for updating the data of the first version to the data of the second version. With reference to the data of the first version stored in the first memory 250 and using the map data, the second version of the program can be quickly generated and loaded on the second memory 260.

The install data of the upgrade package can be produced with or without the map data at the upgrade package processor 10. Accordingly, the upgrade package downloaded from the upgrade package server 20 may or may not include the map data. In the case that the upgrade package has no map data, the installer 230 can produce the map data by comparing the data of the first version stored in the first memory 250 and the upgrade package and analyzing the comparison result for mapping the upgrade data of contained in the upgrade package to the data of the first version. The upgrade data can be structured as shown in FIG. 3F. The reason why the map data is generated by the installer 230 is to increase the second version generation speed of the translator 240. In the case where the upgrade data contains mapping information for mapping the upgrade data to the data of the first version, the upgrade data can be directly replaced or replaced with reference to map data generated afterward.

Although it is preferred to upgrade the first version with the latest upgrade package, the first version can be upgraded with an upgrade package for another version of the program. This is possible because the recipient device 30 provides for the storage of different versions of upgrade packages. Accordingly, if the second version generation fails with a particular upgrade package, it is possible to try to generate the second version using another upgrade package stored in the first memory 250.

The first memory 250 can be implemented with several storage regions for storing upgrade packages, respectively (in this embodiment, 6 upgrade packages can be stored). Accordingly, even though a new upgrade package is downloaded for the upgrade package server 20, a previously downloaded upgrade package is not deleted. The upgrade records are stored as upgrade history, while maintaining the upgrade and install data for the first version of the program. Since the information on the first and second versions are maintained with the upgrade history, the upgrade can be performed with a high fault tolerance. For example, when the last upgrade package does not work, another upgrade package can be used by user selection. Even in the worst case where all of the upgrade packages do not work, the original version of the program can be recovered.

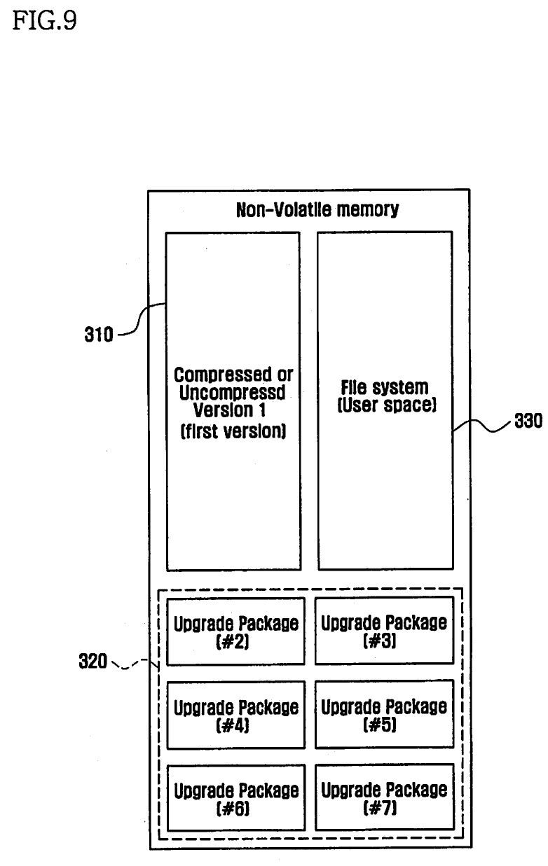

FIG. 9 is a block diagram illustrating a configuration of a first memory of a recipient device of FIG. 8. Referring to FIG. 9, the first memory includes a first storage region 310, a second storage region 320, and a third storage region 330.

The first storage region 310 stores the first version of the program in the form of raw data or compressed data. The second storage region 320 stores at least one upgrade package for generating a new version of the program. Each upgrade package includes the upgrade data and install data. The upgrade data may include commands with block indexes for updating the data of an old version, or data to be added for the new version. Accordingly, the size of the second storage region 320 is determined based on the number of upgrade packages stored therein. The third storage region 330 is a user space for storing user data with a file system.

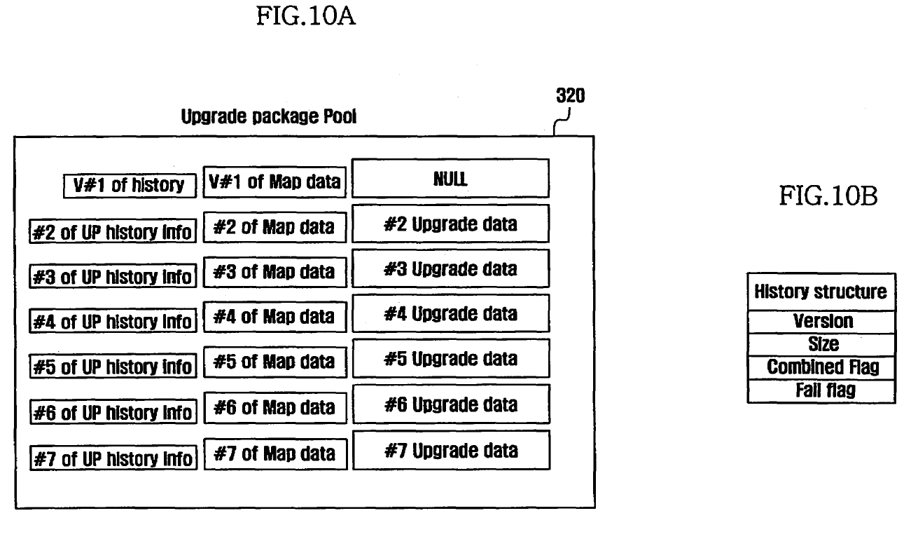

FIG. 10A is a diagram illustrating a structure of the second storage region 320 of the first memory 250 of FIG. 9, and FIG. 10B is a diagram illustrating a data format of the history data of each upgrade package stored in the second storage region 320 of FIG. 10A.

Referring to FIG. 10A, the second storage region 320 is provided with a predetermined number of storage regions for storing the upgrade packages (in this embodiment, 6 upgrade packages). Each storage region is structured to store history data, map data, and upgrade data constituting the upgrade package. Typically, the upgrade package includes install data and upgrade data, and the install data is composed of history data or history and map data. The second storage region 320 can be configured to separately store the history data and map data. The history data is stored for maintaining a link to the first version stored within the first storage region 310. The map data and upgrade data of the first version may not be stored or may exist as null data. FIG. 10A shows an example of the upgrade package composed of the history data, map data, and upgrade data. In the case that the upgrade package processor 10 generates the upgrade package with the history data and the map data, the second storage region 320 can be structured with the storage regions for storing the history data and map data of corresponding version.

Referring to FIG. 10B, the history data includes a version field, a size field, a combined flag field, and a fail flag field. Here, the version field contains a version number of the upgrade package (one of #2 to #7 in FIG. 10A), the size field contains a size value of the history data, the combined flag field contains a version number of a target version to be upgraded (in this example, the version number #1 of the first version), and the fail flag field contains information indicating the occurrence of a loading failure. The version number #1 of the first version can be contained in the version field and linked to the combined flag field. For example, if a version field and combined flag field of the history data of an upgrade package, respectively contain #5 and V#1, the recipient device 30 upgrades the first version of #1 by merging the second version of #5 and the first version of #1. The downloaded upgrade package is stored into the second storage region 320 of the first memory 310 shown as shown in FIG. 9 in the structure of FIG. 10. When an upgrade package stored in the second storage region 320 is requested, the requested package is merged with the first version stored in the first storage region 310 such that the first version is upgraded to the second version.

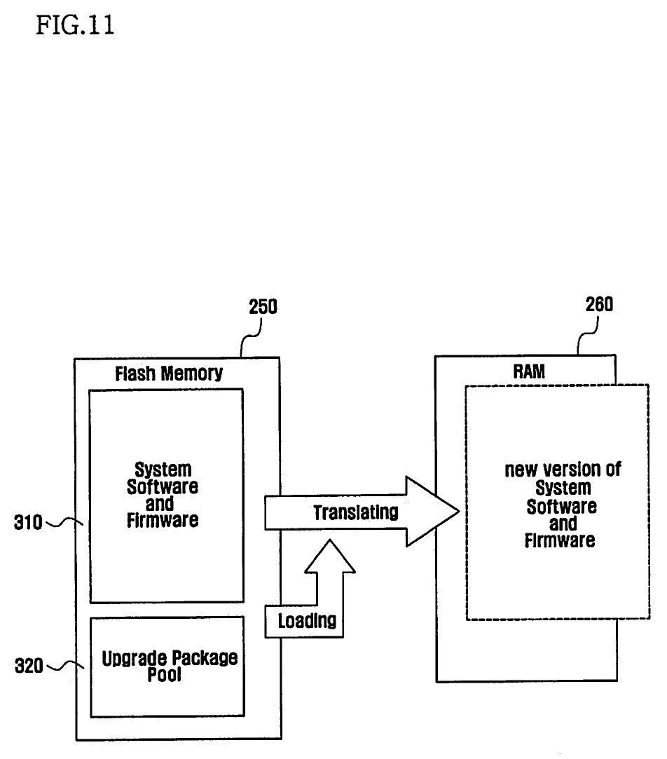

FIG. 11 is a block diagram illustrating an upgrade operation of a program upgrade system according to an exemplary embodiment of the present invention. In the example shown in FIG. 11, the first memory is a non-volatile memory such as flash memory, and the second memory is a volatile memory such as a random access memory (RAM).

Referring to FIG. 11, if an upgrade request is input, a loader (not shown) loads an upgrade package of the requested version from the second storage region 320 of the first memory 250, and the translator 240 generates a second version of the program by merging the loaded upgrade package and the first version of the program stored in the first storage region 310 and then loads the second version on the second memory 260. The upgrade request is generated in response to a user command. That is, the recipient device 30 outputs an alert for notifying the user of an issuance of an upgrade package when an upgrade package is downloaded, or there exists a downloaded package which is not applied such that the user can trigger an upgrade to the target program. If the upgrade request is input by the user in response to the upgrade alert, the recipient device 30 performs an upgrade process as described above and loads the upgraded version of the program on the second memory 260. Accordingly, the recipient device 30 operates afterward with the second version.

The upgrade process can be performed after the recipient device is initialized. As shown in FIG. 9, the first version and upgrade packages of the program are separately stored in the first memory 250 and the program upgrade is performed by merging the first version and one of the upgrade packages such that the second version of the program is generated and loaded on the second memory 260.

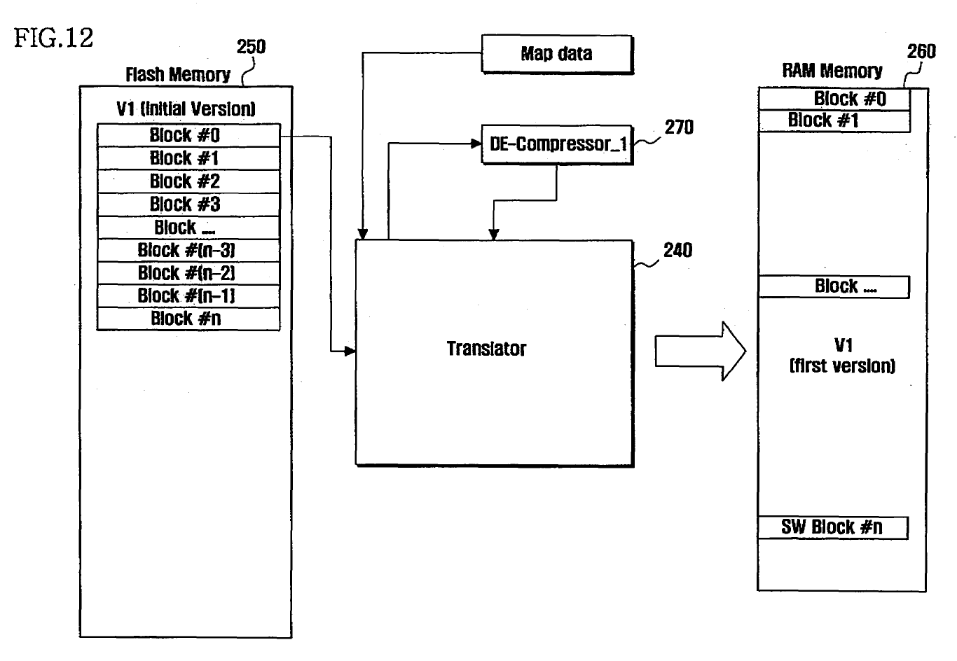

FIG. 12 is a block diagram illustrating an upgrade operation of a program upgrade system according to another exemplary embodiment of the present invention. In this embodiment, the first memory 250 does not store an upgrade package for the second version.

Referring to FIG. 12, the first memory 250 stores the first version of the program. Here, the first version can be an initial version of the program. The first version of the program is composed of n blocks B#1 to B#n. Install data of the first version includes history data and map data. The history data has a version field set to #1 and a combined flag field set to #1. The map data can be structured in the form of one of Tables 1 to 3.

If an upgrade request command is input, the translator 240 analyzes the install data. In the case where no upgrade package exists in the first memory 250, a map data region is in a null state or provided with map data {C:0,n, F:0, null, null}. Such map data implies a command to load the first version of the program stored in the first memory 250 into the second memory, whereby the translator 240 copies the first version from the first memory 250 and loads the copied first version into the second memory 260. Accordingly, the recipient device 30 is operated by the first version loaded in the second memory 260. The first version can be stored in the first memory 250 in a compressed state. In this case, the translator 240 decompresses the compressed first version using the decompressor 270 and then loads it in the second memory 260. Also, when an upgrade package compressed by the second compressor 140 of the upgrade package processor 10 is downloaded, the translator 240 performs translation after the compressed upgrade package is decompressed by the decompressor 270, before loading in the second memory 260.

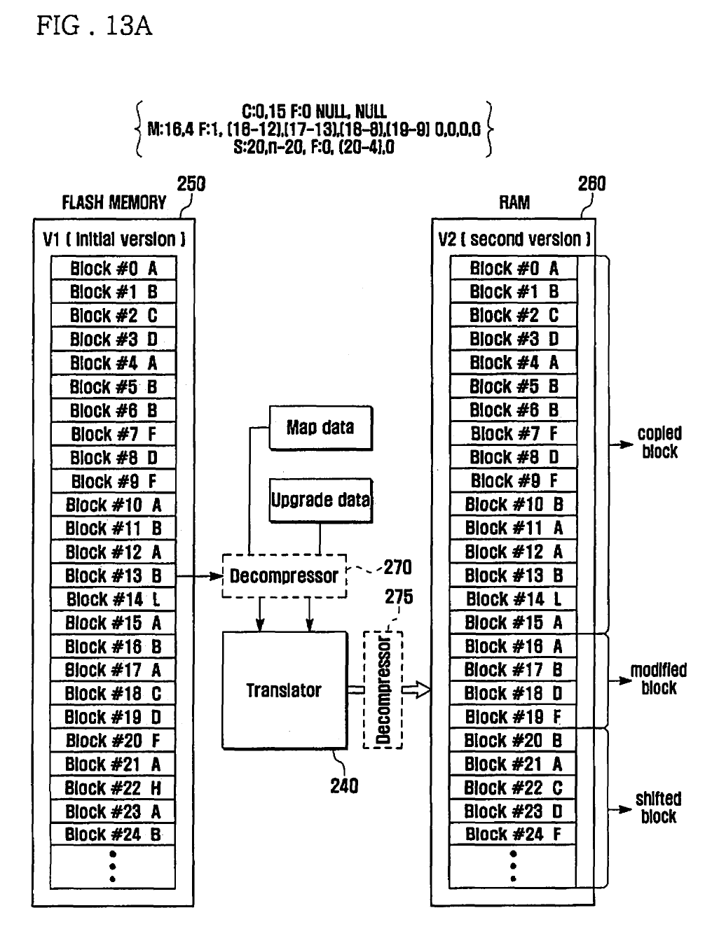

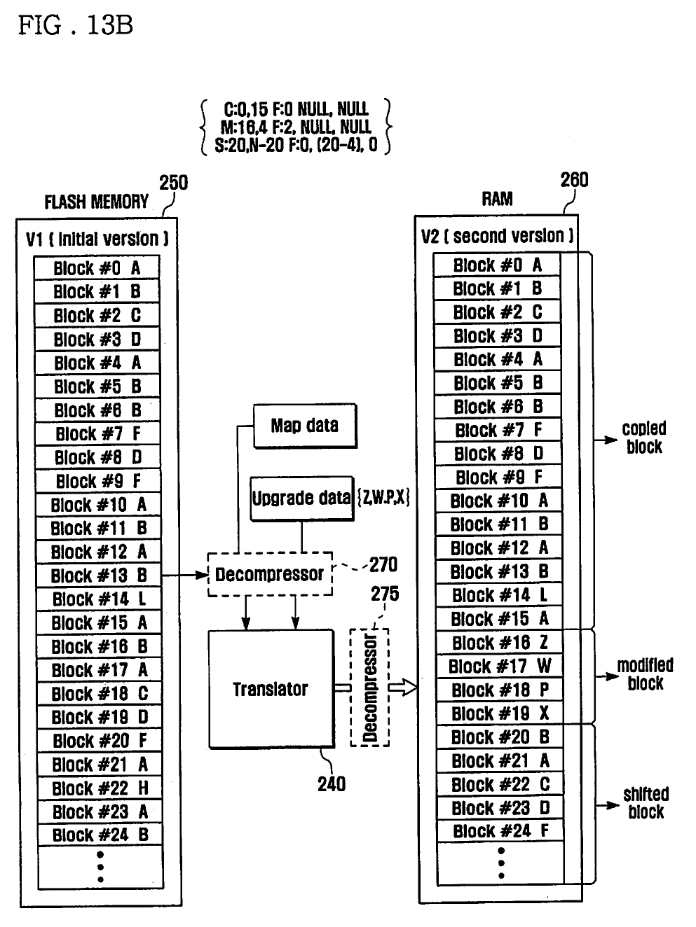

FIGS. 13A and 13B are block diagrams illustrating an upgrade operation of a program upgrade system according to another exemplary embodiment of the present invention. In this embodiment, the first version V1 is stored in the first storage region 310 of the first memory 250 and the upgrade packages are stored in the second storage region 320 of the first memory 250. The first version can be an initial version or a preset reference version, and each upgrade package is composed of upgrade data and install data. The install data includes history data containing version numbers of the second version and a target version to be upgraded (in the example, the first version), and map data. The first version is composed of n blocks B#1 to B#n as in FIGS. 13A and 13B. The combined flag field of the history data is set to #0 and the map data can be structured in the form of one of Tables 1 to 3.

Referring to FIG. 13A, the first storage region 310 of the first memory 250 stores the first version of the program, and a specific upgrade package stored in the second storage region 320 of the first memory 250 has the map data in the form of Table 1. The history data of the upgrade package has a flag for merging the upgrade package with the first version. In this case, the translator 240 upgrades the first version to the second version with reference to the map data and loads the second version into the second memory 260. The map data includes information for copying the 0^{th} to 15^{th} blocks of the first version, copying the 12^{th}, 13^{th}, 8^{th}, and 9^{th} of the first version for the 156^{th} to 19^{th} blocks of the second version, and right-shifting the blocks following the 15^{th} block of the first version. Accordingly, the translator 240 upgrades the first version with reference to the map data and loads the upgraded program, i.e. the second version, into the second memory 260 as shown in FIG. 13B.

In the case where there exists a gap between the blocks, the blocks are shifted to the gap.

Referring to FIG. 13B, the first storage region 310 of the first memory stores the first version of the program, and the second storage region 320 of the first memory 250 stores the upgrade packages. It is assumed that a specific upgrade package has its map data structured in the form of Table 3. The history data of the upgrade package has a flag for indicating the merge of the first version and the upgrade package. The map data has information for copying the 0^{th} to 15^{th} blocks of the first version; inserting the upgrade data {Z,W,P,X} for the 16^{th} to 19^{th} blocks of the second version, and right-shifting the blocks following the 15^{th} block of the first version. In this manner, the translator 240 upgrades the first version with reference to the map data.

After the program is upgraded, the recipient device 30 is operated by the second version of the program that is upgraded in accordance with the examples of FIGS. 13A and 13B. The first version and the upgrade packages can be stored in compressed states. The upgrade packages can be downloaded as a compressed package or compressed after being downloaded. In the case where the first version and the upgrade packages are stored in the compressed states, the translator 240 decompresses the compressed first version and the upgrade packages using the decompressor 270 for use in an upgrade process. In the case where the first and second versions are compared in the compressed states (when the first and second versions are compressed by the first compressor 160 of the upgrade package processor 10), the blocks input to the translator 240 can be in compressed states. In this case, the translator 240 decompresses the compressed data of the first version and the upgrade package using the decompressor 275 and loads the decompressed data into the second memory 260.

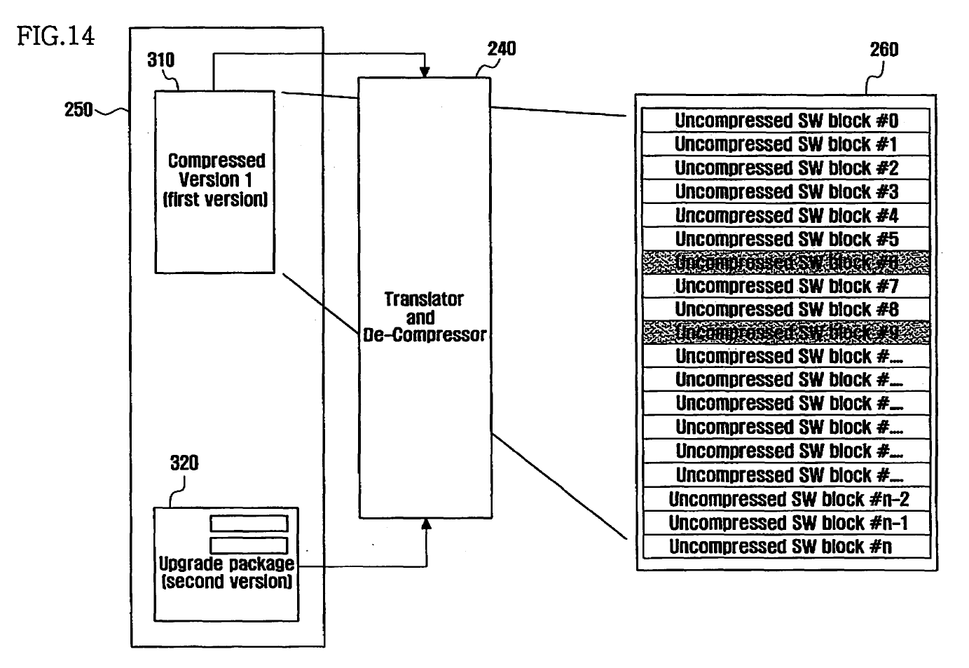

FIG. 14 is a block diagram illustrating an upgrade operation of the recipient device of the program upgrade system according to an exemplary embodiment of the present invention.

Referring to FIG. 14, the first memory 250 stores the first version of the program and upgrade packages for the second version. The translator 240 merges an upgrade package and the first version in response to an upgrade command such that the second version is generated and loaded into the second memory 260. After the second version of the program is loaded into the second memory 260, the recipient device 30 is operated by the second version of the program. The upgrade process can be repeatedly performed when the recipient device 30 is initialized or an upgrade command is input.

As described above, the program upgrade method according to an embodiment of the present invention downloads an upgrade package through a predetermined communication standard channel, stores the downloaded upgrade package, performs upgrade of the program using the stored upgrade package, loads the upgraded program, and operates the recipient device under the control of the upgraded program.

The program upgrade method of the present invention can be an upgrade package generation procedure, a downloaded install data processing procedure, a downloaded upgrade package management procedure, and an upgrade execution procedure.

In the upgrade package generation procedure, the first and second versions of the program are input to the upgrade package processor 10. The first and second versions can be input in a raw or in a compressed state. Next, the first and second versions are compared such that differences between the two versions are determined. On the basis of the differences, install data including map data for merging the upgrade package with the first version installed in the recipient device are generated. The install data is packed into an upgrade package together with upgrade data, and the upgrade package is transmitted to the upgrade package server.

In the downloaded install data processing procedure, the upgrade package transmitted to the upgrade package server is downloaded to a recipient device. The recipient device can obtain the install data contained in the upgrade package by comparing the upgrade package with a reference version (here, the first version), and the install data to facilitate an address calculation. That is, when merging the first version, stored in the first memory 250, and the upgrade package into the second memory 260, the data of the first version and upgrade package can be quickly processed on a block basis using the install data.

In the upgrade package management procedure, the install data is used for fast address calculation referring to the map data that are obtained by comparing the upgrade package and the first version, and for facilitating the merging of the first version and the upgrade package into the second memory 260.

The upgrade package installation can be performed depending on whether or not the map data is packed in the upgrade package. In the case where the map data is packed in the upgrade package, the recipient device 30 extracts the history data, map data, and upgrade data from the upgrade package and independently stores the extracted data in the upgrade package regions of the first memory 250.

On the other hand, if no map data is contained in the upgrade package, the recipient device 30 can obtain the map data by comparing the first version stored in the first memory 250 and the downloaded upgrade package. At this time, the map data can be integrated into the upgrade data as shown in FIG. 3F. In this case, the recipient device extracts the map data from the upgrade data during the install process and install the map data in a map data region. The recipient device also extracts the upgrade data and installs it in the upgrade package storage region. Accordingly, the recipient device can install the upgrade package in the same manner as the map data is packed in the upgrade package. The install data also includes history data of the upgrade package. The history data indicates the versions of the upgrade packages and the target program. In this embodiment, 6 upgrade packages can be stored in the first memory 250. When a merge failure occurs with a specific upgrade package, the recipient device allows the user to select another upgrade package by displaying an upgrade package list.

In the upgrade execution procedure, the upgrade packages are stored in corresponding storage regions prepared in the first memory 250. Accordingly, when a new upgrade package is downloaded, the previously downloaded upgrade package is not erased. Accordingly, when a specific upgrade package is not loaded, the recipient device 30 allows the user to select another upgrade package for program upgrade by displaying an upgrade package list. Even in the worst case where all of the upgrade packages are not loaded, the first version of the program can be loaded.

FIG. 15 is a flowchart illustrating a program upgrade method according to an exemplary embodiment of the present invention. The steps of the program upgrade method are depicted in relation to the operations of the upgrade package processor 10 and the recipient device 30 of the program upgrade system of FIG. 1.

Referring to FIG. 15, the upgrade package processor 10 receives the first and second versions of a program in step S411. An upgrade package is generated, when a new version of the program is introduced, by comparing the old version, i.e. the first version, and the new version, i.e. the second version. The upgrade package is composed of upgrade data and install data. The first version can be an original version or a reference version that is programmed to be merged with upgraded packages. The upgrade package is an information package for upgrading the first version of the program installed in the recipient device to the second version. The recipient device can store at least one upgrade package.

If the first and second versions of the program are received, the upgrade package processor 10 analyzes the differences between the first and second versions in step S413, and generates upgrade package on the basis of the analysis result in step S415. The upgrade package can include upgrade data and install data containing information for combining the upgrade data with the first version. The install data includes history data providing a history of the second version and map data providing information for mapping blocks of the first and second versions of the program. The map data does not have to be contained in the install data. In this case, the recipient device can generate the map data in the program upgrade process. The install data are provided for facilitating the program upgrade process. If the upgrade package is successfully generated, the upgrade package processor 10 transmits the upgrade package to the upgrade package server 20. Upon receiving the upgrade package, the upgrade package server 20 transmits an upgrade notification message to the recipient device 30. If an upgrade notification message is received, the recipient device 20 starts downloading the upgrade package in response to a user command. The download procedure can be determined on the basis of the communication standard supported by the recipient device 30. The communication standards include CDMA, UMTS, GSM, WiBro, Wi-Fi, WiMAX, Bluetooth, UWB, Zigbee, and USB.

If the upgrade package download is started, the recipient device 30 receives the upgrade package in step S451 and stores the downloaded upgrade package into the first memory 250. The first memory 250 is provided with the first storage region 310 for storing the first version of the program and a second storage region 320 for storing the upgrade packages. The second storage region 320 can be structured in the form of multiple storage regions for storing corresponding upgrade packages. In this embodiment, the second storage region 320 has 6 storage regions. Each storage region can separately store the history, map data, and upgrade data.

In the case where the map data is not contained in the install data of the downloaded upgrade package, the installer 230 of the recipient device 30 generates the map data with reference to the upgrade package and the first version of the program. After the upgrade package is stored in the first memory 250, the recipient device 30 upgrades, in response to a user command or a reboot, the program to the second version by merging the upgrade package and the first version and then loads the second version of the program on the second memory 260 in step S455. Accordingly, the recipient device 20 is operated afterward under the control of the second version of the program. The second memory 260 can be a working memory such as a volatile memory. In such a manner, the recipient device 30 generates the second version of the program by merging the first version stored in the first memory 250 and the recently downloaded upgrade package in a system initialization process, and loads the second version on the second memory 260 for controlling operations of the recipient device 30. When the program upgrade fails with respect to a specific upgrade package, the recipient device 30 can automatically try upgrading the program with another upgrade package stored in the first memory 250. Also, the recipient device 30 allows the user to select an upgrade package by providing an upgrade package list such that the first version is upgraded with a selected upgrade package.

An upgrade package generation procedure is described hereinafter in more detail.

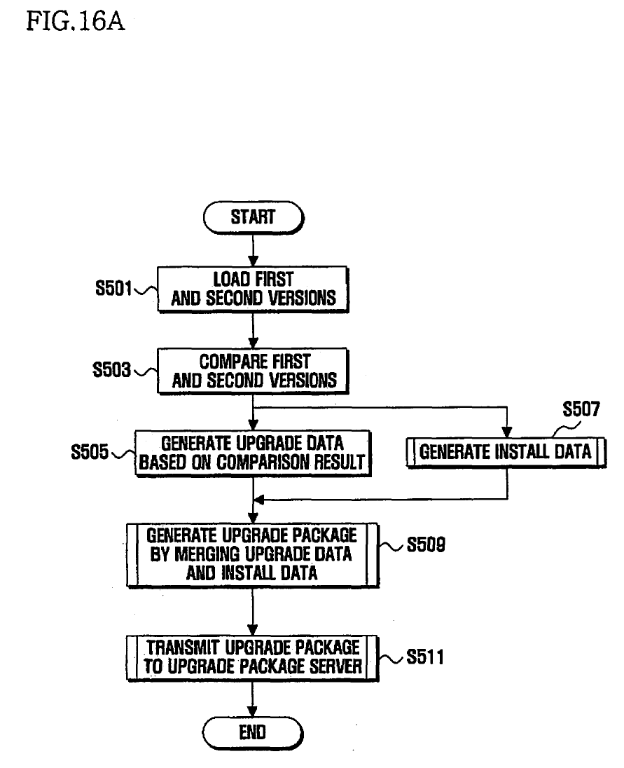

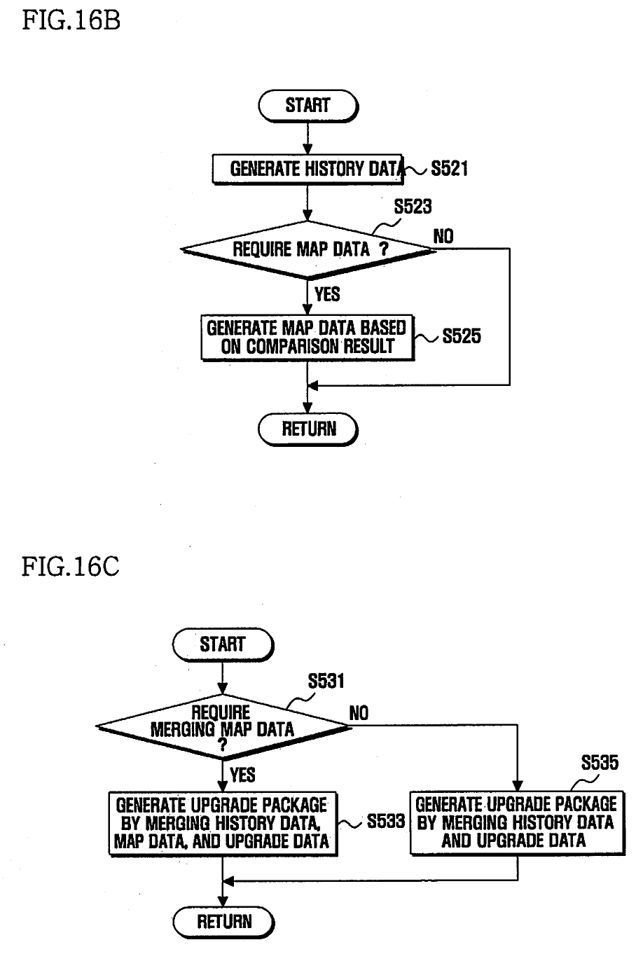

FIGS. 16A to 16C are flowcharts illustrating an upgrade package generation procedure of a program upgrade method according to an exemplary embodiment of the present invention.

Referring to FIG. 16A, the upgrade package processor 10 loads the first and second versions of the program in a memory in step S501, and compares the two versions with each other to determine differences between the two versions in step S503. After determining the differences between the first and second versions, the upgrade package processor 10 generates comparison analysis data. Next, the upgrade package processor 10 generates upgrade data in step S505 and install data in step S507 on the basis of the comparison analysis. The upgrade package processor 10 can be implemented with a package generator 130 and an install data generator 180. In this case, the upgrade data and install data can be generated in parallel processes. The package generator 130 also can be implemented to generate the upgrade data and the install data in series. In this case, the upgrade data can be generated before or after the generation of the install data.

The install data provides information for merging the upgrade package with the first version of the program in the form indicating the history data and map data. The history data contains information on the versions of the first and second versions of the program and the size of the versions. The map data includes provides information for mapping blocks of the first and second versions of the program. The map data can be generated at the upgrade package processor 10 or at the recipient device 30. Accordingly, the map data does not have to be packed in the upgrade package.

FIG. 16B is a flowchart illustrating the install data generation procedure of step S507 of FIG. 16A, and FIG. 16C is a flowchart illustrating upgrade package generation procedure of step S509 of FIG. 16A.

Accordingly, in the install data generation procedure of FIG. 16B, the map data may or may not be generated. Also, in the upgrade package generation procedure of FIG. 16C, the map data may or may not be merged.

Referring to FIG. 16B, the upgrade package processor 10 generates the history data in step S521 and determines if map data is required for the upgrade package in step S523. If the map data is required, the upgrade package processor 10 generates the map data with reference to the comparison analysis in step S525.

Referring to FIG. 16C, the upgrade package processor 10 determines whether to pack the map data in the upgrade package in step S531. If it is determined to pack the map data in the upgrade package, the upgrade package processor 10 generates the upgrade package with the map data in step S533, and otherwise, the upgrade package processor 10 generates the upgrade package without map data in step S535. The map data can be structured as shown Tables 1 to 4 in association with FIGS. 3A to 3C.

At step S501 of FIG. 16A, the first and second versions of the program can be input in a state of raw data or compressed data (for example, the first and second versions can be compressed by the first compressor 160). Also, the upgrade package generated at step S509 can be compressed before transmitting to the upgrade package server (for example, the upgrade package can be compressed by the second compressor 140 of the upgrade package processor 10). By compressing the first and second versions, the data processing needed for comparing the first and second version can be reduced. The compression of the upgrade package can reduce the transmission data amount. When the data compression is applied, the compressed data is decompressed in order to perform a reliability test. Only when the compressed data passes the test, can the next process be performed.

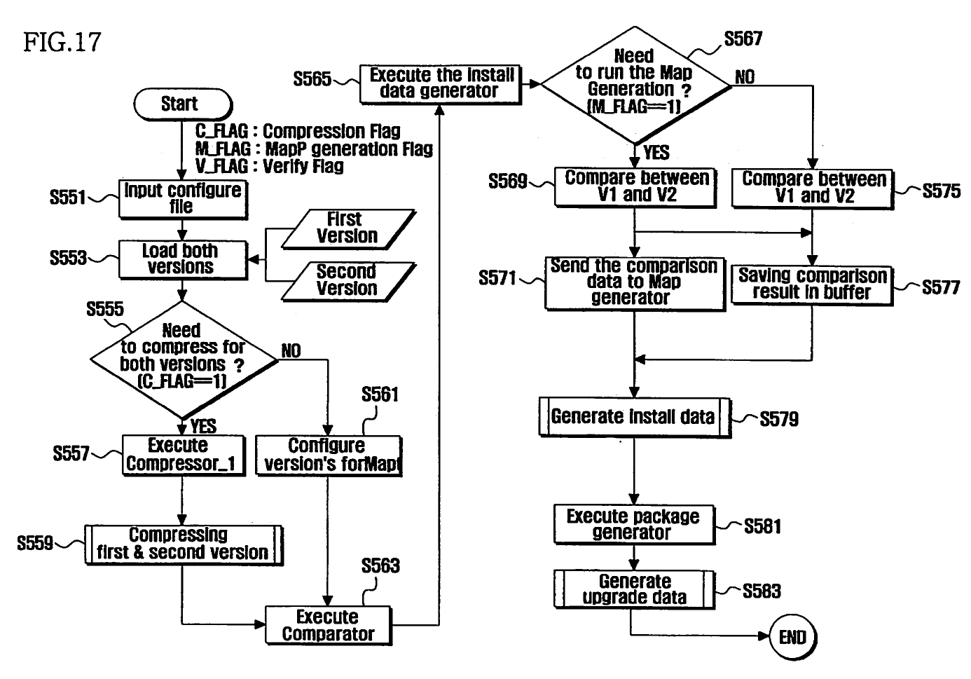

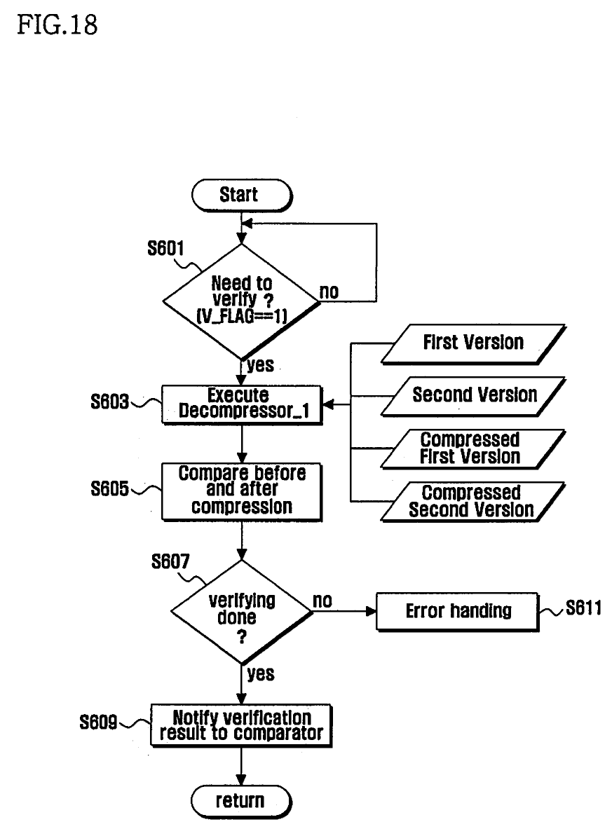

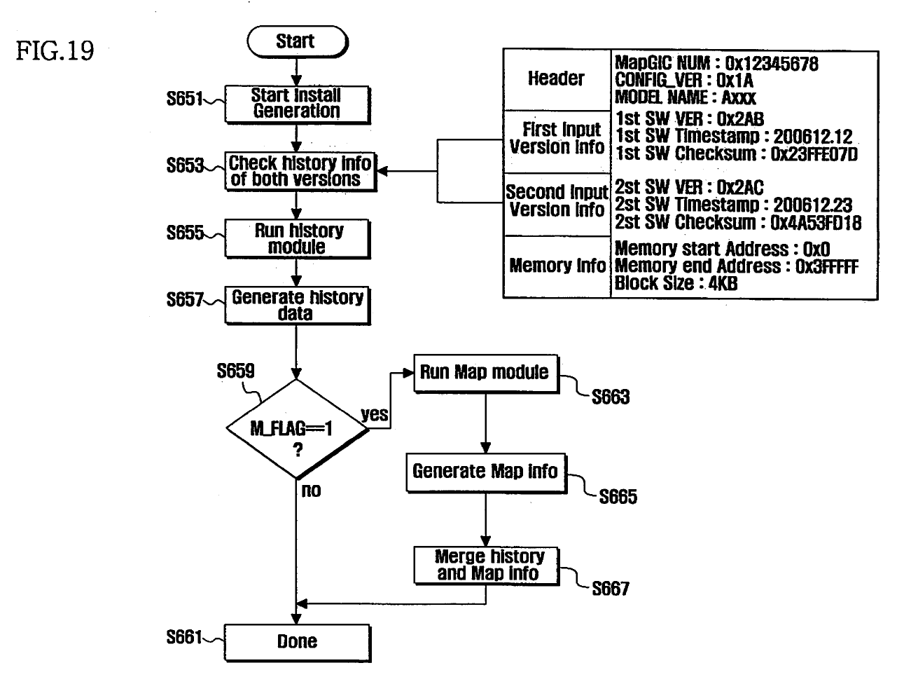

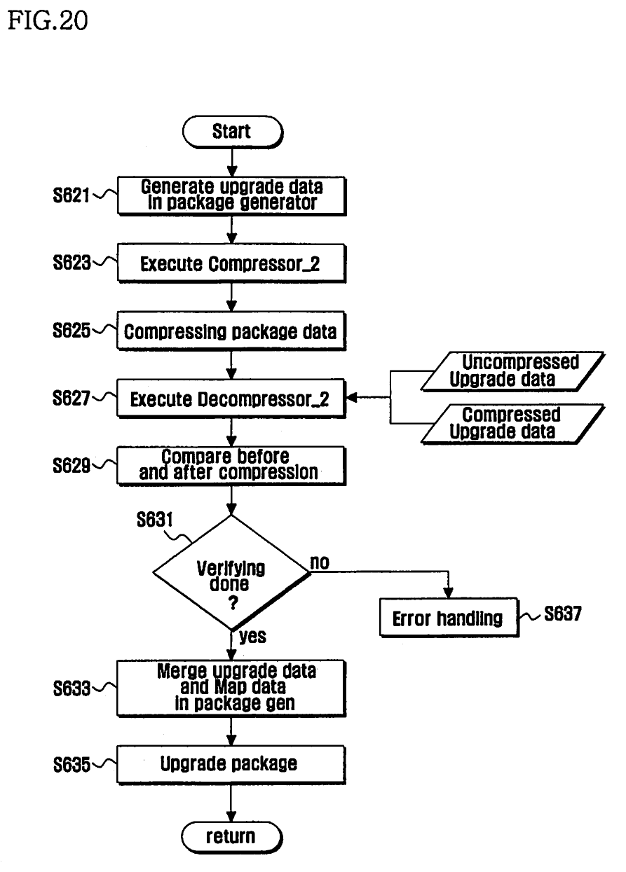

FIG. 17 is a flowchart illustrating an upgrade package generation procedure of a program upgrade method according to an exemplary embodiment of the present invention. FIG. 18 is a flowchart illustrating a compression reliability test procedure of FIG. 17. FIG. 19 is a flowchart illustrating an install data generation procedure of FIG. 17. FIG. 20 is a flowchart illustrating an upgrade package generation procedure of FIG. 17.

Referring to FIGS. 17 to 20, a configure file is input to the upgrade package processor 10 in step S551. The configure file includes flags for defining operations of the upgrade package processor 10. Among the flags, C_FLAG is a compression flag for configuring whether or not to apply data compression, M_FLAG is a map generation flag for configuring whether or not to generate map data, and V_FLAG is a verify flag for verifying whether or not the compression is normally performed by decompressing compressed information. Next, the upgrade package processor 10 loads both the first and second versions of the program in step S553. The first version can be an initial version or a reference version for upgrading the program, and the second version is the last version of the program.

After loading the two versions, the upgrade package processor 10 determines whether to compress the both versions referring to C_FLAG in step S555. If no compression is required, the upgrade package processor 10 configures the two versions for generating a map in step S561. If the C_FLAG is set to 1 (C_FLAG=1), i.e. the data compression is required, the upgrade package processor 10 executes a compressor (compressor_1) in step S557 and controls the compressor to compress the first and second versions of the program in step S559. Next, the upgrade package compressor 10 executes a comparator to compare the compressed two versions in step S563.

The compression procedure at step S559 is performed as shown in FIG. 18. In the case where the compression flag is set, the verify flag is set in general. If the verify flag (V_FLAG) is set, the upgrade package processor 10 decompresses the compressed data and compares the decompressed data to the original data before the compression.

Referring to FIG. 18, after compressing the first and second versions of the program, the upgrade package processor 10 determines if the verify flag is set to 1 (V_FLAG=1) in step S601. If the verity flag is set to 1, the upgrade package processor 10 executes a decompressor (Decompressor_1) to decompress the compressed first and second versions in step S603 and compares the data before and after the compression in step S605. Next, the upgrade package processor 10 verifies a successful compression by determining if the data before and after the compression are identical with each other in step S607. If the compression is verified, the upgrade package processor 10 sends the verification results to the comparator 110 in step S609, and otherwise, the upgrade package processor 10 executes an error handling process in step S611. In this case, the upgrade package processor 10 may again perform the compression on the first and second versions.

Returning to FIG. 17, after comparing the first and second versions at step S563, the upgrade package processor 10 executes an install data generator 180 to generate install data in step S565. The install data generator 180 may or may not generate a map depending on the value of M_FLAG. Accordingly, the upgrade package processor 10 determines if the map flag is set to 1 (M_FLAG=1) in step S567. If the map flag is set to 1, the upgrade package processor controls the comparator 110 to compare the first and second versions in step S569. The data comparison is performed in unit of block of a predetermined data size. If a block having different data is found in the comparison process, an identical block search is performed in the search range of the first version as shown in FIGS. 3A to 3C.

The first and second versions are compared in a raw data state or a compressed data state. After completing the comparison, the upgrade package processor 10 controls the comparator 110 to transmit the comparison result to the install data generator 180 in step S571 and save the comparison result in a storage region in step S577. In a case that the map flag is set to 0 (M_FLAG=0), the upgrade package processor 10 controls the comparator to compare the first and second versions in step S575 and save the comparison result for use in generating the install data in the storage region in step S577. The first and second versions are compared in a raw data state or a compressed data state. When the map data is required, the upgrade package processor 10 controls the transmission of the comparison result to the install data generator 180 and saves the comparison result in a storage region for use in generating the map data and the upgrade data. When the map data is not required, the upgrade package processor 10 controls the saving of the comparison result in the storage region for use in generation of upgrade data.

Next, the upgrade package processor 10 controls the install data generator 180 to generate the install data in step S579. The install data generation procedure is performed as shown in FIG. 19. Referring to FIG. 19, the upgrade package processor 10 controls the install data generator 180 to start generating the install data in step S651 and checks history information of the first and second versions in step S653. Next, the upgrade package processor 10 runs a history data generator 120 in step S655, such that the history data generator generates the history data in step S657. The history data has a format composed of a header, first input version information, second input version information, and memory information. Each of the first and second input version information is composed of a version identifier (SW VER), a time stamp (SW time stamp), and a checksum (SW checksum). That is, the history data provides information on the version numbers of the first and second versions.

After the history data is generated, the upgrade package processor 10 determines if the map flag is set to 1 (M_FLAG=1) in step S659. If the map flag is set to 1, the upgrade package processor 10 runs a map data generator 150 in step S603, and the map data generator 150 generates the map data (S665). The map data includes commands such as copy (C), modify (M), and shift (S). The map data is set per block. The map data is generated on the basis of the comparison result of the first and second versions such that the blocks of which data are identical with those of previous version are set with C, the blocks additionally inserted to the previous version or modified from the blocks of the previous version are set to M, and the blocks located at the positions to be occupied by inserted or modified blocks are set with S. That is, the map data is composed of the block indexes and data indicating the differences between the first and second blocks. As described above, the map data is produced in the format of [Cmd][start block No, number of block][flag][distance][difference]. When the first and second versions are given in FIGS. 3A to 3C, the map data is structured as shown in Tables 1 to 3. In this case, the upgrade data becomes the blocks associate with command M, i.e. modified data. After generating the map data, the upgrade package processor 10 merges the history data and the map data in step S667. Accordingly, the install data is generated with or without the map data in step S661.

Returning to FIG. 17, after the install data is generated, the upgrade package processor 10 executes the package generator 130 in step S581 and the package generator 130 generates the upgrade package in step S583.

FIG. 20 is a flowchart illustrating an upgrade package generation procedure of a program upgrade method according to another exemplary embodiment of the present invention.

Referring to FIG. 20, the upgrade package processor 10 controls the package generator 130 to generate upgrade data on the basis of the comparison result. When blocks identical with the modified blocks of the second version are not found in the first version, the package generator 130 sets the modified blocks as the upgrade data. The location of the upgrade data is determined depending on the map data. Although it is assumed that the upgrade package includes the history data, map data, and install data in this embodiment, the upgrade package can be composed without map data. In the case that the upgrade package is composed of only the install data, the upgrade package processor 10 generates the map date having mapping information on the blocks of the second version that are different form the first version and the different blocks themselves.

When the install data has no map data, the upgrade package generator 130 can generate the upgrade data having the indexes of the blocks of the second version that are to be combined with the first version. In this case, the upgrade data can be structured in the format having commands C, M, and S as shown in FIG. 3F. That is, the upgrade data for copying a block from the first version includes a start block index and a number of the blocks to be copied, the upgrade data for adding or modifying blocks of the first version includes a start block index, a number of the blocks to be inserted or modified, and concatenated block data for the blocks to be inserted or modified, and the upgrade data for shifting blocks of the first version includes a number of the blocks to be shifted and a block index of a first block to be shifted. In this manner, the upgrade data includes the map information.

Preferably, the upgrade data is transmitted in the compressed state. Accordingly, the upgrade package processor 10 executes the compressor (Compressor_2) in step S623 and controls the compressor to compress the upgrade data in step S625. Sequentially, the upgrade package processor 10 executes the decompressor (Decompressor_2) for verifying the compression in step S627 and controls the comparator to compare the data before and after the compression in step S629. If the compression is verified at step S631, the upgrade package processor 10 generates an upgrade package by merging the upgrade data and the install data in step S633 and transmits the upgrade package to the upgrade package server 20 in step S635. If the compression failure is detected at step S631, the upgrade package processor 10 performs an error handling process in step S637.

The upgrade package is distributed to the recipient devices 30 in accordance with a download procedure. The upgrade package is composed of the upgrade data generated on the basis of the difference between the first and second version and the install data for installing the upgrade data.

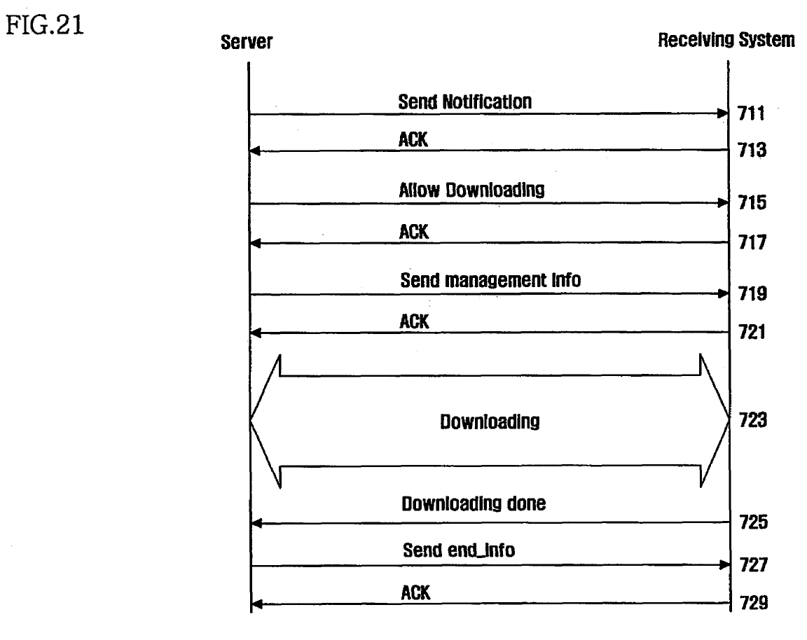

FIG. 21 is a message flow diagram illustrating a program download procedure of a program upgrade method according to an exemplary embodiment of the present invention.

Referring to FIG. 21, if an upgrade package is received from the upgrade package processor 10, the upgrade package server 20 transmits a notification message to the recipient device 30 in step S711. The upgrade package server 20 and the recipient device 30 are connected through a communication channel established on the basis of a communication standard such as CDMA, UMTS, GSM, WiBro, Wi-Fi, WiMAX, Bluetooth, UWB, Zigbee, and USB.

In response to the notification message, the recipient device 30 transmits an acknowledgement message (ACK) to the upgrade package server 20 in step S713. Upon receiving the ACK, the upgrade package server 20 transmits a download allowance message to the recipient device 30 in step S715. If an ACK is received from the recipient device 30 in response to the download allowance message, the upgrade package server 20 transmits management information message to the recipient device 30 in step S719. By transmitting an ACK to the upgrade package server 20 in response to the management information message, the recipient device 30 start downloading the upgrade package from the upgrade package server 20 in step S723. If the upgrade package is successfully downloaded, the recipient device 30 transmits a download complete message to the upgrade package server 20 in step S725, and the upgrade package server 20 transmits a transmission end information message (send end_info) to the recipient device 30 in step S727. By receiving, at the upgrade package server 20, an ACK from the recipient device 30 in response to the transmission end information message in step S729, the update package download procedure ends.

As described above, the upgrade package server 20 notifies the recipient devices 30 of the issuance of the upgrade package such that the recipient devices 30 download the upgrade package. The recipient device 30 stores the upgrade package downloaded from the upgrade package server 20 into the first memory 250 and starts upgrading a target program in response to a user command such that the upgraded version of the program is loaded on the second memory 260.

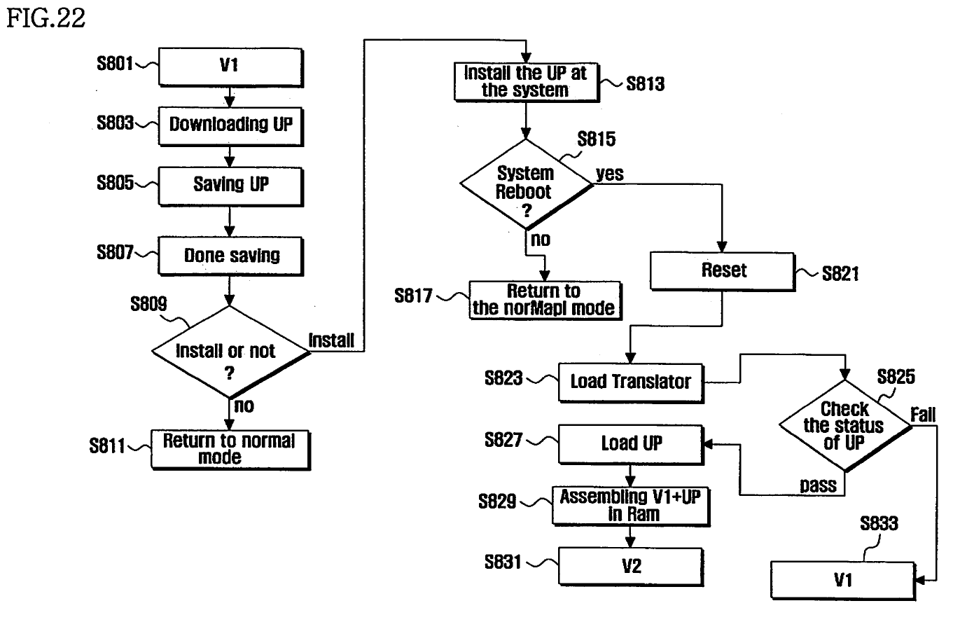

FIG. 22 is a flowchart illustrating a downloaded upgrade package processing procedure of a program upgrade method according to an exemplary embodiment of the present invention.

Referring to FIG. 22, the recipient device 30 stores the first version of the program within the first memory 250 in step S801. The first version can be a version installed in the first memory 250 during the manufacturing phase of the recipient device 30, or a reference version installed later. If an upgrade package notification message is received, the recipient device 30 downloads the upgrade package through the procedure depicted in FIG. 21. The recipient device 30 downloads the upgrade package form the upgrade package server 20 and temporarily stores the downloaded upgrade package through steps S803 to S807. The upgrade package can be immediately installed in the first memory 250 or installed after a normal operation of the recipient device 30 ends. After the upgrade package is downloaded, the recipient device 30 determines if an install command is input in step S809. If no install command is input, the recipient device 30 returns to the normal operation mode in step S811.

If an install command is input, the recipient device 30 installs the upgrade package into the first memory 250 in step S813. The first memory 250 is a non-volatile memory and comprises separate regions for storing the first version and multiple upgrade packages. That is, the first memory 250 is composed of the first and second storage regions as shown in FIGS. 9, 10A, and 10B. The upgrade packages are stored in an order of issuance times with such that the upgrade history is secured.

After the upgrade package is installed, the recipient device 30 determines whether a system reboot command is input in step S815. If no system reboot command is input, the recipient device 30 returns to the normal operation mode in step S817. In this case, since the program is not yet upgraded, the recipient device 30 operates with the previous version.

If a reboot command input is detected at step S813, the recipient device 30 reboots to be initialized in step S821 and executes the translator 240 for activating the second version from the downloaded upgrade package in step S823.

The translator 240 merges the upgrade package installed in the first memory 250 and the first version of the program so as to generate and load the second version in the second memory 260. Accordingly, the recipient device 30 operates afterward under the management of the second version of the program.

Next, the recipient device 30 checks a status of the upgrade package to determine if the upgrade is successfully performed or failed in step S825. If the upgrade failed, the recipient device loads the first version of the program in step S833. If the upgrade is successfully performed, the recipient device 30 loads the upgrade package in step S827 and assembles the upgrade package and the first version in the second memory 260 in step S829 and then operates under the management of the second version on the second memory in step S831.

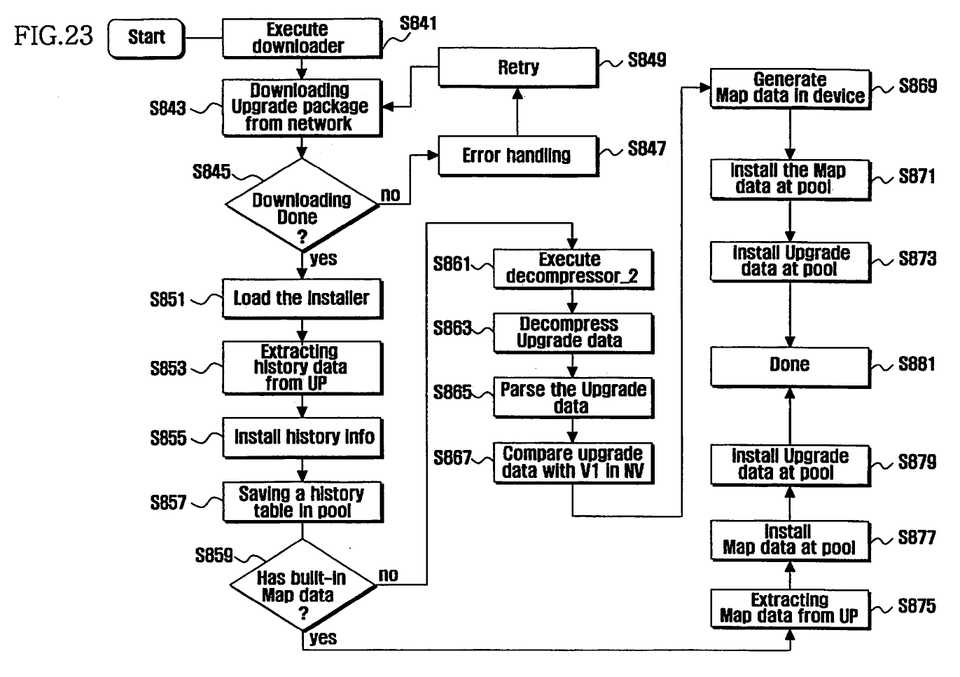

FIG. 23 is a flowchart illustrating an upgrade package install procedure of a program upgrade method according to an exemplary embodiment of the present invention.

Referring to FIG. 23, in an upgrade package download command is input, the recipient device 30 executes a downloader in step S841 and controls the downloader to download the upgrade package from the upgrade package server 20 in step S843. The upgrade package download can be performed in different manner depending on the communication standard adopted by the recipient device 30. That is, the recipient device 30 can be one of CDMA, UMTS, GSM, WiBro, Wi-Fi, WiMAX, Bluetooth, UWB, and Zigbee enabled terminals, or can be connected to the upgrade package server 20 through a USB.

During the download session, the recipient device 30 detects if the upgrade package is successfully downloaded in step S845. If an error is detected, the recipient device 30 performs an error handling process in step S849 and then retries the download of the upgrade package in step S849.

If the upgrade package is successfully downloaded, the recipient device 30 executes an installer in step S851. Next, the recipient device 30 controls the installer to extract the history data from the upgrade package in step S853, gathers history information from the history data in step S855, and builds a history table in the first memory in step S857. Next, the recipient device 30 detects if map data is packed in the upgrade package in step S859. If map data is packed in the upgrade package, the recipient device 30 extracts the map data from the upgrade package in step S875, stores the map data an upgrade data in corresponding storage regions of the first memory 250 in steps S877 and S879. Consequently, the history data, map data, and upgrade data packed in the upgrade package are installed in the first memory 250 in step S881.

If map data is not packed in the upgrade package, the recipient device 30 executes a decompressor (decompressor_2) in step S861. Next, the recipient device 30 controls the decompressor to decompress the upgrade data packed in the upgrade package in step S863 and parse the upgrade data in step S865. Next, the recipient device 30 compares the upgrade data with the first version in the first memory 250 in step S867 and generates map data with reference to the comparison result in step S869. Next, the recipient device 30 stores the map data generated in the recipient device and the upgrade data packed in the upgrade package into the upgrade package storage region of the first memory in steps S871 and S873. Consequently, the history data, map data, and upgrade data packed in the upgrade package are installed in the first memory 250 in step S881. In the case where the upgrade data includes information on the map data, the map data generation process can be skipped. That is, the upgrade data can be structured with information on the map data as shown in FIG. 3F. In the case of FIG. 3F, the upgrade data is provided with commands for processing respective blocks and corresponding block indexes such that the recipient device 30 can independently generate the map data map data from the upgrade data. Also, since the map data generation process is not required, the steps S861 to S873 can be skipped. In this case, the translator combines the upgrade data with the first version with reference to the information on the map data incorporated in the upgrade data. In this embodiment, when the upgrade data incorporates the information on the map, the installer generates the map data from the update data such that update data and the install data are installed in the upgrade package region in the same data format and processed by the translator in the same format.

As depicted in FIG. 23, the recipient device 30 downloads the upgrade package and installs the history data, map data, and upgrade data packed in the upgrade package within corresponding storage regions of the first memory 250. At this time, the map data may or may not be packed in the upgrade package. When no map data is packed in the upgrade package, the recipient device 30 stores the upgrade package within the first memory 250 and compares the upgrade package with the first version so as to generate map data on the basis of the comparison analysis and stores the map data in the upgrade package storage region.

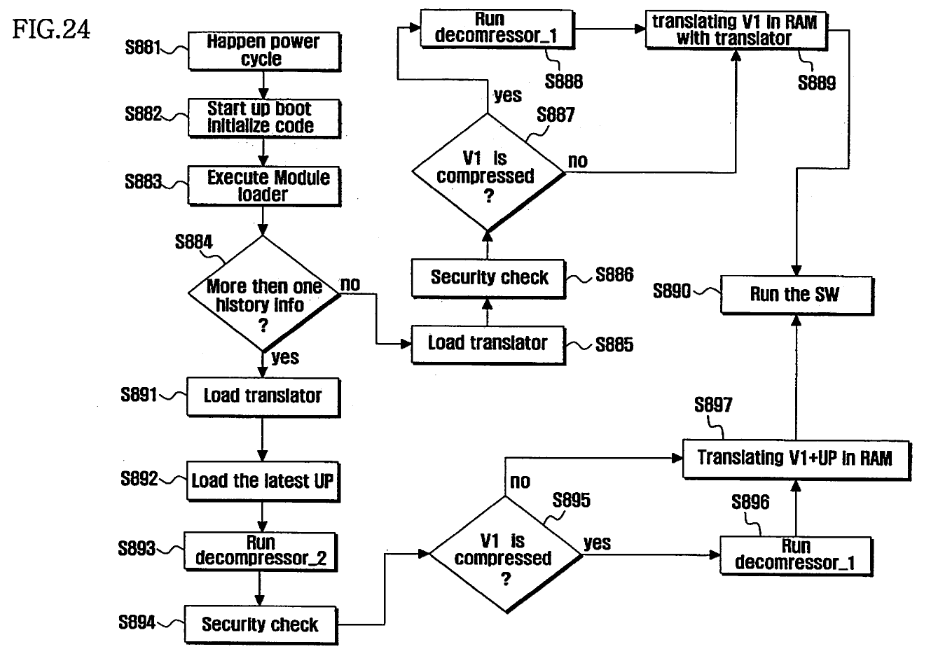

FIG. 24 is a flowchart illustrating an upgraded program running procedure of a program upgrade method according to an exemplary embodiment of the present invention.

Referring to FIG. 24, the upgraded program is activated when the recipient device 30 is turned on, or in response to a user command. After the recipient device 30 is initialized, the second version of the program upgraded by combining the first version and the last downloaded upgrade package is loaded in the second memory 260 for operating the recipient device 30. The information stored in the second memory 260 is represented by a program that can run in a volatile memory.

If the recipient device 20 is turned on in step S881, the recipient device 30 starts booting the system and initializes codes in step S882 and executes a loader in step S883. Next, the recipient device 30 scans the upgrade package storage regions of the first memory 250 and checks for the upgrade packages in step S884. If no upgrade package exists, the recipient device 30 executes the translator 240 in step S885 and controls the translator to perform security check and validity check of the version in step S886. Next, the recipient device 30 determines if the first version stored in the first memory 250 is compressed in step S887. If it is determined that the first version is compressed, the recipient device 30 runs the decompressor (decompressor_1) 270 to decompress the first version in step S888 and controls the translator to translate the first version in the second memory 260 in step S889 such that the first version of the program runs. If it is determined that the first version is not compressed at step S887, the recipient device 30 skips step S888 and performs steps S889 and S890.

Returning to step S884, if at least one upgrade package exists in the first memory 250, the recipient device 30 executes translator 240 in step S891 and loads the recently downloaded upgrade package in step S892. The upgrade package can be composed of at least two of the history data, map data, and upgrade data.

Next, the recipient device 30 runs the decompressor (decompressor_2) 270 to decompress the loaded upgrade package (only the upgrade data may be compressed) in step S893 and performs security check and validity check of the version in step S894. Next, the recipient device 30 determines if the first version stored in the first memory 250 is compressed in step S895. If it is determined that the first version is compressed, the recipient device 30 runs the decompressor (decompressor_1) 270 to decompress the first version in step S896 and controls the translator to translate and combine the first version and the upgrade package in the second memory 260 in step S897 such that the upgraded version of the program runs in step S890. If it is determined that the first version is not compressed at step S895, the recipient device 30 skips step S896 and performs steps S897 and S890.

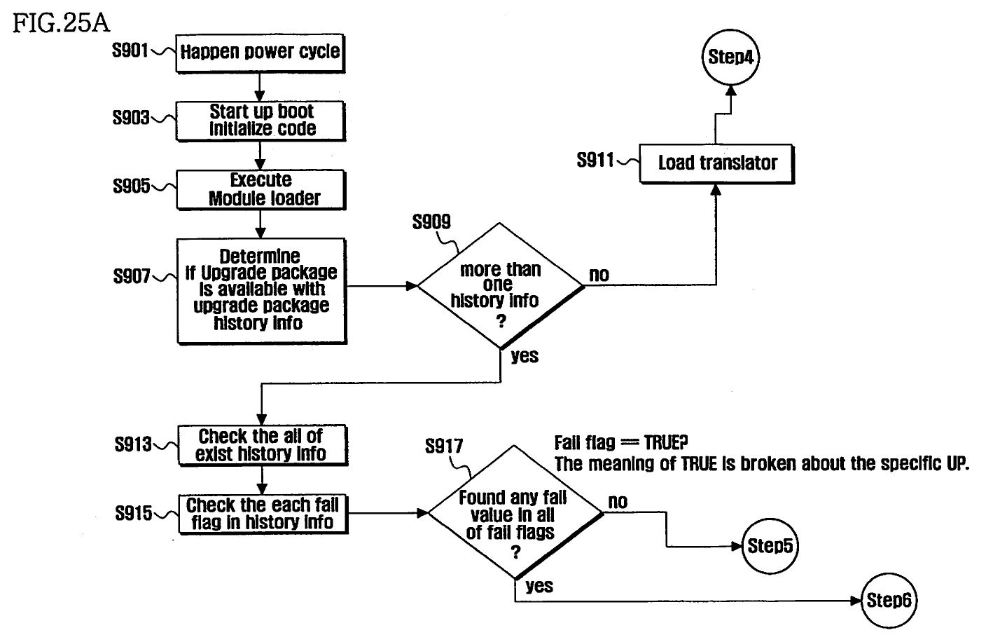

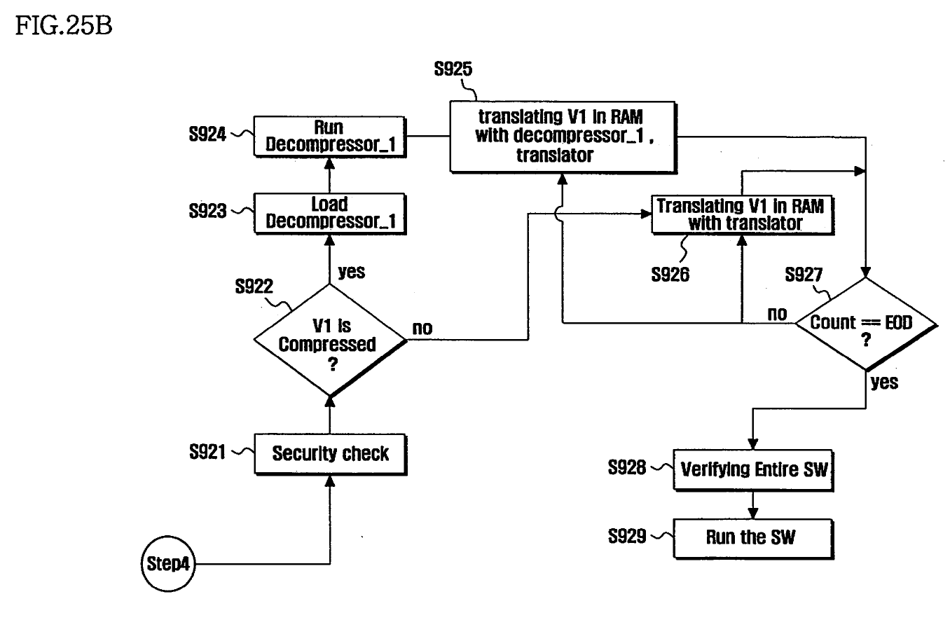

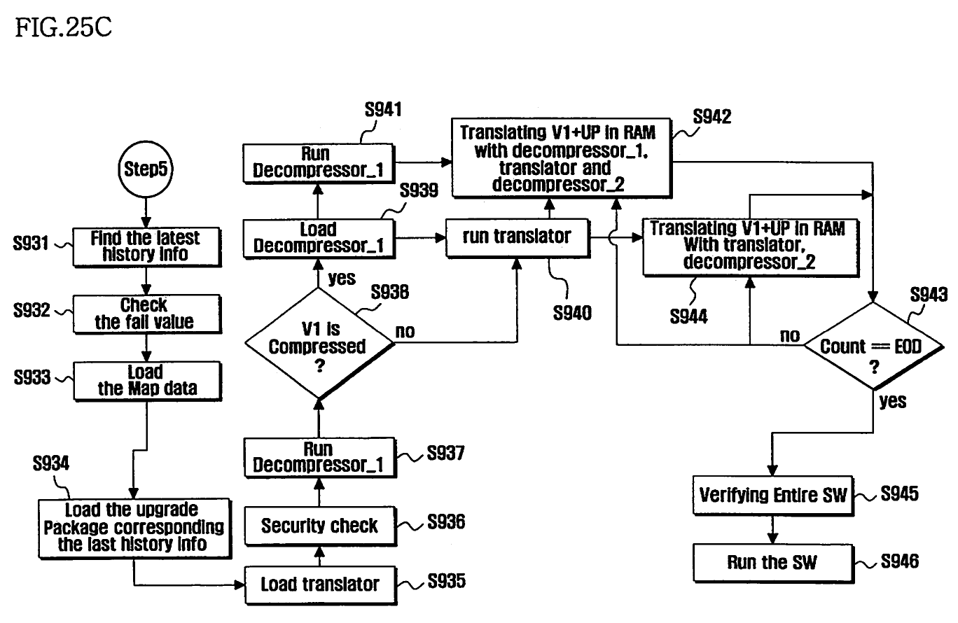

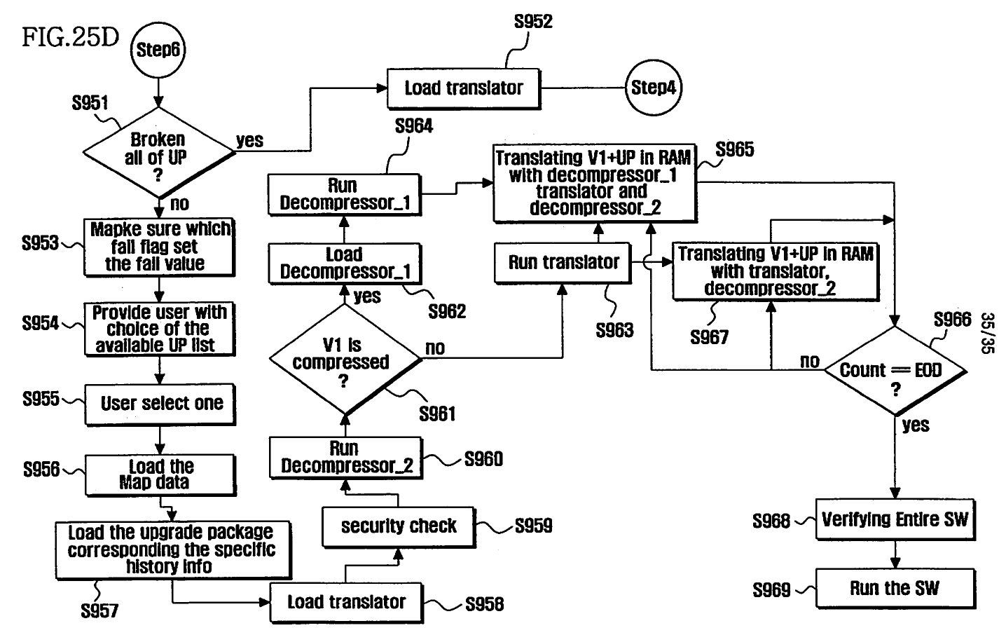

FIGS. 25A to 25D are flowcharts illustrating an upgrade program running procedure of a program upgrade method according to another exemplary embodiment of the present invention.

Referring to FIGS. 25A to 25D, if the recipient device 30 is turned on in step S901, the recipient device starts booting the system and initializes codes in step S903 and executes a loader in step S905. Next, the recipient device 30 determines if any upgrade package is available with reference to the history of upgrade packages in step S907 and checks the upgrade packages in step S909. If no upgrade package exists, the recipient device 30 executes the translator 240 in step S911 and performs security check in step S921 (see FIG. 25B). Next, the recipient device 30 determines in step S922 if the first version stored is compressed. If it is determined that the first version is compressed, the recipient device 30 runs the decompressor (decompressor_1) 270 and the translator in steps S923 and S924 and controls the decompressor and the translator to cooperatively decompress and translate the first version in step S925. While decompressing and translating the data of the first version, the recipient device 30 monitors the processes to detect if the first version is completely translated, using a counter (Count=EOD) in step S927. The decompression and translation processes repeat until the counter reaches the end of the data (EOD) (Count=EOD) in the second memory 260. If it is determined that the first version of the program is not compressed at step S922, the recipient device 30 controls the translator to translate the first version in the second memory 260 without decompression in step S926 until the counter reaches the end of the data. If the counter reaches the EOD, the recipient device 30 verifies the entire data of the translated first version of the program in step S928 and runs the first version for operating the system.

Returning to FIG. 25A, if at least one upgrade package exists in the first memory 250 at step S909, the recipient device inspects the history information of all the upgrade packages in step S913 and checks fail flags in the history information in step S915. The fail flag indicates if loading the upgrade package has failed. If the fail flag is set to true (fail flag=true), the upgrade package has failed. For this reason, the recipient device 20 determines if the fail flag of the history information of upgrade packages is set to “true” in step S917. If the fail flag is not set to “true,” the recipient device 30 performs the program upgrade procedure through steps S931 to S946 of FIG. 25C. In contrast, if the fail flag is set to “true,” the recipient device 30 performs the program upgrade procedure through steps S951 to S969 of FIG. 25D.

As shown in FIG. 25C, if the fail flag is not set to “true,” the recipient device 30 checks the history data of the latest upgrade packages in step S321 and checks the fail flag of the history data in step S932. If the fail flag is not set to “true,” the recipient device 30 loads the map data and upgrade data of the upgrade package in steps S933 and S934. Next, the recipient device 30 loads the translator in step S935, performs security checks in step S936, and loads the decompressor (Decompressor_1) in step S937. Next, the recipient device 30 determines in step S938 if the first version of the program is compressed. If the first version is compressed, the recipient device 30 runs the decompressor and the translator in steps S939, S940, and S941. Next, the recipient device 30 controls the first and second decompressors and the translator to decompress and translate the first version and the upgrade package in the second memory 260 in step S942. While decompressing and translating the data of the first version and the upgrade package, the recipient device 30 monitors the processes to detect if the process is completed with reference to a counter (Count=EOD) in step S943. The decompression and translation processes are repeated until the counter reaches the EOD. If it is determined at step S938 that the first version is not compressed, the recipient device 30 runs the translator in step S940 and controls the translator to translate the data of the first version and the upgrade package in the second memory without decompression process in step S944 until the counter reaches the EOD. If the counter reaches the EOD, the recipient device 30 verifies the entire data of the translated first version and the upgrade package in step S945 and runs the upgrade version of the program for operating the system in step S946.

The map data contained in the upgrade package can be structured as shown in Tables 1 to 4. In the case of Table 1, 2, or 4, the translator 240 of the recipient device 30 generates the second version by merging the first version of the program and the upgrade package with reference to the map data.

Referring to Table 1 of the map data {C:0,15, F:0, null, null), {M:16,4 F:1, (16-12), (17-13), (18-8), (19-9), 0,0,0,0}, (S:20,5, F:0, (20-4), 0}, the recipient device 30 processes the blocks indexed with the commands C, M, and S and upgrades the first version in accordance with the map data. That is, the recipient device 30 copies the 0^{th} to 15^{th} blocks of the first version and pastes the copied blocks into the second version with the same block indexes, copies the 12^{th}, 13^{th}, 8^{th}, and 9^{th} blocks of the first version and pastes the copied blocks for the 16^{th} to 19^{th} blocks of the second version, and copies the 16^{th} to 20^{th} blocks of the first version and pastes the copied blocks for the 20^{th} and 24^{th} blocks of the second version.

Referring to Table 2 of the map data (C:0,15, F:0, null, null}, (M:16,4 F:1, (16-12),(17-13),(18-8),(19-9), 0,code(B,K),code(E,C),0}, (S:20,5, F:0, (20-4), 0}, the recipient device 30 copies the blocks of the first version and places the copied blocks for the second version in accordance with the index map following the commands C and S, and generates block data using the block indexes and entropy-coded data following the command M. That is, the recipient device 30 copies the 0^{th} to 15^{th} blocks of the first version and pastes the copied blocks into the second version with the same block indexes, places the 12^{th} block, code (B,K), code (E,C), and 9^{th} block of the first version for the 16^{th} 19^{th} blocks of the second version, and places the 16^{th} to 20^{th} blocks of the first version for 20^{th} to 24^{th} blocks of the second version. Here, the code (B,K) means data obtained by entropy-coding the difference between the 13^{th} block of the first version and 17^{th} of the second version, and code (E,C) means a data obtained by entropy-coding the difference between the 8^{th} block of the first version and the 18^{th} block of the second version.

Referring to Table 3 of the map data {C:0,15, F:0, null, null}, {M:16,4, F:2, null, null}, {S:20,5, F:0, (20-4), 0}, the recipient device 30 copies the blocks of the first version and places the copied blocks for the second version in accordance with the index map following the command C and S, and generates block data using the block indexes and update data following the command M. That is, the recipient device 30 copies the 0^{th} to 15^{th} blocks of the first version and places the copied blocks in the second version with the same block indexes, and places the blocks contained in the upgrade data for the 16^{th} to 19^{th} blocks of the second version. Accordingly, the 16^{th} to 19^{th} blocks of the second version have data Z, W, P, and X (see FIG. 3C).

In the case where the upgrade package is composed of the history data and the update data without map data, the recipient device 30 can generate the map data by comparing the first version of the program and the upgrade data and analyzing the comparison result. The map data generation process can be skipped. In this embodiment, the installer generates the map data using the map information incorporated into the upgrade data. Referring to Table 4 of the map data (C:0,6},{M:6,2,X,Y}, (S:8,3,6,} {S:11,2,13}, {M:13,5, A,B,C,D,E}, {S:18,7,15}, the installer 230 of the recipient device 30 generates map data in association with the commands C and S. In association with the command M, however, the installer 230 generates map data and/or update data on the basis of the map information implied in the upgrade package. The map data and upgrade data are separately stored in the upgrade package region.

As shown in FIG. 25D, if the fail flag is set to “true,” at step S917 of FIG. 25A, the recipient device 30 checks if all fail flags of the upgrade packages are set to “true” in step S951. If all the fail flags are set to “true,” the recipient device 30 loads the translator in step S925 and performs step S921. That is, if all the upgrade packages have errors, the recipient device 30 loads the first version of the program into the second memory 260 such that the recipient device 30 operates under the control of the first version. The first version may be an original version of the program installed during the manufacturing phase.

If not all of the fail flags of the upgrade package are set to “true,” the recipient device 30 checks the upgrade packages of which fail flags are not set to “true” in step S953 and displays available upgrade packages in step S954. If a selection command is input in step S955 for selecting one of the available upgrade packages, the recipient device 30 loads the map data and upgrade data of the selected upgrade package in association with the history information in steps S956 and S957. Next, the recipient device 30 executes the translator in step S956 and performs security check on the data in step S959. Next, the recipient device 30 runs the decompressor (Decompressor_2) for decompressing, if the upgrade data are compressed, the upgrade data in step S960. Next, the recipient device 30 determines if the first version of the program is compressed in step S961. If the first version is compressed, the recipient device 30 runs the first decompressor (Decompressor_1) and the translator in steps S962, S963, and S964. Next, the recipient device 30 controls the first and second decompressors and the translator to decompress and translate the first version and the upgrade package in the second memory 260 in step S965. While decompressing and translating the data of the first version and the upgrade data, the recipient device 30 monitors the processes to detect if the process is completed with reference to the EOD (Count=EOD?) in step S966. The decompression and translation process are repeated until the counter reaches the EOD.

As described above, in the program upgrade method according to an embodiment of the present invention, the upgrade package provider generates an upgrade package in accordance with the differences between old and new versions of a target program, and the recipient device downloads and upgrades an old version to the new version such that the upgraded new version of the non-volatile memory is loaded into the volatile memory for operating the recipient device.

The upgrade package generation mechanism has the following characteristics.

If two versions of the program are input, the upgrade package processor compares the two versions and generates comparison result data using the differences of the two versions. Here, the first version is a reference version which can be a program installed during the manufacturing phase or a program decided afterward. The second version is an upgraded version of the program to be downloaded by the recipient device for upgrading the first version of the program. Multiple upgrade versions can be issued, so the second version can be one of the upgrade versions, particularly, the latest version.

The two versions can be compared before or after being compressed. In the case of comparison after compression, a compression verification process can be performed by decompressing each compressed version and comparing the data before and after the compression.

The install data is generated on the basis of the comparison result data. The install data is the data providing information on how to install the update data to the first version.

The install data must include history data. The install data also contains version identifiers of the first and second versions and a flag indicating a history of loading failure. The install data can include map data in addition to the history data. The map data is data providing information on how to map the update data to the first version. The map data is provided with commands such as “copy”, “modify”, and “shift”, and block indexes for mapping the blocks in the first version. If it is required that the second version is produced by inserting some blocks into the first version and the blocks to be inserted are identical or at least similar, the blocks can be informed by the map data rather than packing the blocks themselves.

The install data can be integrated into the upgrade data. In this case, the upgrade package processor compares the first and second versions of the program in block units. When the number of the blocks is changed, i.e. some blocks are removed or added or the data of each block is modified, such information is incorporated into the upgrade data as the install data. In this case, the update data includes the modify command M of the map data. The install data also can be provided without map data. In this case, the map data is produced at the recipient device. When the upgrade data is provided with the map data, the map data generation process is not required.

The upgrade data or the upgrade package can be provided in a compressed form. In this case, the upgrade package processor decompresses the compressed upgrade data or package and compared the data before and after compression for verifying successful compression.

The upgrade package generated by the upgrade package processor 10 is transmitted to the upgrade package server 20, and the upgrade package server 20 notifies the recipient device 30 of the issuance of the upgrade package such that the recipient device downloads the upgrade package.

The recipient device 30 installs the upgrade package in the first memory such as a non-volatile memory and loads the second version upgraded from the first version with the upgrade package in the second memory such as the volatile memory such that the recipient device operates under the control of the second version of the program.

As described above, in the program upgrade system and method of the present invention, an upgrade package generated on the basis of differences between a reference version and a new version of a program, resulting in fast upgrade package generation. Since the first version and the upgrade package downloaded from a network are separately installed in a non-volatile storage area and loaded as an upgrade version on the volatile storage area, it is possible to secure operability of the program even in an upgrade failure situation. Also, since the program upgrade system and method of the present invention enables installing multiple upgrade packages separately in a non-volatile storage area, it is possible to operate the recipient device with user-preferable version of the program. Also, the program upgrade system and method is advantageous in the program version can be selected by the user.

Furthermore, since the upgrade of V1 itself is not performed on the first memory, a fault tolerant control effect can be implicitly expected. This is because the operation stability is secured even when the program upgrade fails with an upgrade package using the V1 of the first version stored in the first memory.

Although exemplary embodiments of the present invention have been described in detail hereinabove, it should be clearly understood that many variations and modifications of the basic inventive concepts herein taught which may appear to those skilled in the present art will still fall within the spirit and scope of the present invention, as defined in the appended claims.

What is claimed is:

1. A program upgrade method in a network, comprising:
generating an upgrade package on the basis of differences between a first version of a program and a second version of the program;
notifying at least one recipient device of an issuance of an upgrade package at the upgrade package server; and
downloading the upgrade package from the upgrade package server to the receipt device, installing the upgrade package in a first memory, and merging the upgrade package and the first version of the program to be loaded as the second version of the program in a second memory in response to an upgrade command.

2. The program upgrade method of claim 1, wherein the upgrade package includes install data for merging the upgrade package with the first version of the program and upgrade data to be combined with the first version of the program.

3. The program upgrade method of claim 2, wherein the install data includes history data for merging the first version of the program and the upgrade package, and map data for mapping the upgrade data to the first version of the program.

4. The program upgrade method of claim 1, wherein generating the upgrade package comprises:
comparing the first and the second versions of the program in a unit of a block;
generating install data containing map data for mapping blocks of the second version of the program to the first version of the program based on the comparison result; and
generating the upgrade package by packing the install data and an upgrade data.

5. The program upgrade method of claim 4, wherein the first version of the program and at least one upgrade package are separately stored in the first memory.

6. The program upgrade method of claim 5, wherein the upgrade command is generated with a selection of a version when the recipient device is initialized or by a key input.

7. The program upgrade method of claim 4, wherein the map data includes indexes of blocks of the second version of the program associated with the program upgrade and upgrade commands for applying the blocks to the first version of the program.

8. The program upgrade method of claim 7, wherein the map data includes command strings each structured in the form of [Cmd][start block No][number of blocks][flag][distance], where the [Cmd] field has a value indicating at least one of commands “copy”, “modify”, and “shift”, the [start block No] field has a block index of a start block the [number of blocks] field has value indicating a number of blocks from the start block, the [flag] field has a value indicating an origin of the blocks, and the [distance] field has a value indicating a distance from a block of the first version of the program to a block of the second version of the program mapped each other.

9. The program upgrade method of claim 8, wherein the command “modify” implies a insertion of a new block or a modification of a block of the first version of the program.

10. The program upgrade method of claim 7, wherein the map data includes command strings each structured in the form of [Cmd][start block No, number of blocks][flag][distance][difference], where the [Cmd] field has a value indicating one of commands “copy”, “modify”, and “shift”, the [start block No, number of blocks] field has a block index of a start block and a value indicating a number of blocks from the start block, the [flag] field has a value informing an origin of the blocks, the [distance] field has a value indicating a distance from a block of the first version of the program to a block of the second version mapped each other, and the [difference] field has a value indicating a difference between the blocks of the first version and the second version of the program.

11. The program upgrade method of claim 10, wherein the [difference] field is set for canceling a generation of upgrade data of a corresponding block.

12. The program upgrade method of claim 11, wherein the first version of the program is an original version of the program installed during a manufacturing phase of the recipient device, and the second version of the program is a program upgraded from the first version of the program, the second version of the program representing multiple versions of the program issued after the first version of the program.

13. A program upgrade package generation method, comprising the steps of:
comparing a first version and a second version of a program in units of a block;
generating upgrade data containing map data for mapping blocks of the second version to blocks of the first version of the program based on the comparison result;
generating an upgrade package by packing history data for indicating a relationship of the upgrade package and the first version of the program and the upgrade data;
advertising an issuance of the upgrade package; and
downloading, the upgrade package to at least one recipient device, installing the downloaded upgrade package in a non-volatile memory, generating the second version of the program by merging an upgrade package with the first version in response to an upgrade request signal, and operating the recipient device with the second version of the program.

14. The program upgrade method of claim 13, wherein the first version of the program and at least one upgrade package are separately stored in the non-volatile memory.

15. The program upgrade method of claim 14, wherein the upgrade command is generated when the recipient device is initialized or by a key input, and the upgrade package is selectable from among multiple upgrade packages.

16. The program upgrade method of claim 15, wherein the upgrade package includes install data having history data for indicating a relationship of the upgrade package and first version of the program to support the merge of the upgrade package and the first version.

17. The program upgrade method of claim 16, wherein the upgrade data includes at least one of copy block data structured in a string of [start block No][number of blocks], modify block data structured in a string of [start block No][number of blocks][data], and shift block data [start block No][number of blocks][previous version position], wherein the [start block No] field has a block index of a start block, the [number of blocks] field has value indicating a number of blocks from the start block, the [data] field contains data of corresponding block, and the [previous version position] field has a start block index for the blocks to be shifted.

18. The program upgrade method of claim 17, wherein the [previous version position] field indicates one of a block number of the second version of the program±a number of blocks and a block number of the second version of the program−a block number of the first version of the program.

19. A program upgrade method in a network including an upgrade package processor for generating an upgrade package for a program and an upgrade package server allowing a recipient device to download the upgrade package, comprising the steps of:
generating the upgrade package based on differences between a first version and a second version of the program at the upgrade package processor;
notifying the recipient device of an issuance of the upgrade package at the upgrade package server;
downloading the upgrade package from the upgrade package server to the recipient device,;
installing the upgrade package in an upgrade package region of a first memory in which the first version of the program is installed;
upgrading the first version to the second version of the program by merging the upgrade package and the first version of the program in response to an upgrade command; and
loading the second version of the program into a second memory.

20. The program upgrade method of claim 19, wherein generating the upgrade package comprises:
comparing the first version and the second version of the program in units of a block;
generating install data containing map data for mapping blocks of the second version of the program to blocks of the first version based on the comparison result; and
generating the upgrade package by packing the install data and upgrade data.

21. The program upgrade method of claim 20, wherein the first memory comprises:
a first version storage region for storing the first version of the program; and
an upgrade package storage region having at least two areas for storing different upgrade packages, the install data and the upgrade data packed in the upgrade package being stored separately.

22. The program upgrade method of claim 21, wherein the install data includes history data for indicating a relationship of the upgrade package and the first version of the program to support the merge of the upgrade package and the first version of the program, and installing the upgrade package comprises:
extracting the history data, the map data, and the upgrade data from the upgrade package;
storing the history data within a history data area of a corresponding upgrade package region;
storing the map data within a map data area of a corresponding upgrade package region; and
storing the upgrade data within an upgrade data area of a corresponding upgrade package region.

23. The program upgrade method of claim 22, wherein upgrading the first version to the second version of the program comprises:
loading the upgrade package of a latest version of the program from the first memory; and
applying the upgrade data of the loaded upgrade package to the first version of the program with reference to the map data of the upgrade package.

24. The program upgrade method of claim 23, wherein the first memory is a non-volatile memory, and the second memory is a volatile memory.

25. The program upgrade method of claim 24, wherein the upgrade command is generated when the recipient device is initialized or by a key input, and a last issued upgrade package among multiple upgrade packages is selected for upgrading the program.

26. A program upgrade method in a network including an upgrade package processor for generating an upgrade package for a program and an upgrade package server allowing a recipient device to download the upgrade package, comprising the steps of:
comparing a first version and a second version the program in units of a block at the upgrade package processor;
generating install data containing map data for mapping blocks of the second version to the first version of the program based on the comparison result; and
generating the upgrade package by merging the install data and upgrade data;
downloading the upgrade package at the recipient device; and
upgrading the first version of the program installed at the recipient device to the second version of the program by applying the upgrade package to the first version.

27. The program upgrade method of claim 26, wherein the map data is structured as a string of [Cmd][start block No][number of blocks][flag][distance], where the [Cmd] field has a value indicating one of commands “copy”, “modify”, and “shift”, the [start block No] field has a block index of a start block, the [number of blocks] field has value indicating a number of blocks from the start block, the [flag] field has a value informing an origin of the blocks, and the [distance] field has a value indicating a distance from a block of the first version to a block of the second version of the program mapped each other.

28. The program upgrade method of claim 27, wherein the command “modify” implies a insertion of a new block or a modification of a block of the first version.

29. The program upgrade method of claim 26, wherein the map data includes command strings each structured in the form of [Cmd][start block No, number of blocks][flag][distance][difference], where the [Cmd] field has a value indicating one of commands “copy”, “modify”, and “shift”, the [start block No, number of blocks] field has a block index of a start block and a value indicating a number of blocks from the start block, the [flag] field has a value informing an origin of the blocks, the [distance] field has a value indicating a distance from a block of the second version to a block of the first version of the program mapped each other, and the [difference] field has a value indicating a difference between the blocks of the first and second versions of the program.

30. The program upgrade method of claim 29, wherein the [difference] field is set for canceling a generation of the upgrade data of a corresponding block.

31. A program upgrade system, comprising:
an upgrade package processor for generating an upgrade package using a first version and a second version of a program;
an upgrade package server for storing the upgrade package and advertising an issuance of the upgrade package; and
at least one recipient device for downloading the upgrade package and upgrading the program using the downloaded package, the recipient device includes a first memory for separately installing the first version of the program and the upgrade package and a second memory for loading the second version of the program upgraded by merging the first version of the program and the upgrade package.

32. The program upgrade system of claim 31, wherein the upgrade package processor comprises:
a comparator for comparing the first version and the second version of the program in units of a block;
an install data generator for generating install data having map data for mapping blocks of the second version to blocks of the first version of the program; and
a package generator for creating the upgrade package by merging the install data and upgrade data.

33. The program upgrade system of claim 32, wherein the recipient device comprises:
an installer for installing the upgrade package within an upgrade package region of the first memory; and
a translator for loading the first version of the program and the upgrade package in the first memory in response to an upgrade command, generating the second version of the program by applying the upgrade package to the first version of the program, and loading the second version of the program into the second memory.

34. The program upgrade system of claim 33, wherein the upgrade command is generated when the recipient device is initialized or by a key input, and a last issued upgrade package among multiple upgrade packages is selected for upgrading the program.

35. The program upgrade system of claim 34, wherein the install data includes history data for indicating a relationship between the upgrade package and the first version of the program.

36. The program upgrade system of claim 35, wherein the map data includes indexes of blocks of the second version of the program associated with the program upgrade and commands for applying the blocks to the first version of the program.

37. The program upgrade system of claim 35, wherein the map data includes command strings each structured in the form of [Cmd][start block No][number of blocks][flag][distance], where the [Cmd] field has a value indicating one of commands “copy”, “modify”, and “shift”, the [start block No] field has a block index of a start block, the [number of blocks] field has value indicating a number of blocks from the start block, the [flag] field has a value informing an origin of the blocks, and the [distance] field has a value indicating a distance from a block of the first version of the program to a block of the second version of the program mapped each other.

38. The program upgrade system of claim 36, wherein the command “modify” implies a insertion of a new block or a modification of a block of the first version.

39. The program upgrade system of claim 35, wherein the map data includes command strings each structured in the form of [Cmd][start block No, number of blocks][flag][distance][difference], where the [Cmd] field has a value indicating one of commands “copy”, “modify”, and “shift”, the [start block No, number of blocks] field has a block index of a start block and a value indicating a number of blocks from the start block, the [flag] field has a value informing an origin of the blocks, the [distance] field has a value indicating a distance from a block of the second version of the program to a block of the second version of the program mapped each other, and the [difference] field has a value indicating a difference between the blocks of the first and second versions of the program.

40. The program upgrade system of claim 39, wherein the [difference] field is set for canceling a generation of upgrade data of a corresponding block.

41. The program upgrade system of claim 40, wherein the first version of the program is an original version of the program installed during a manufacturing phase of the recipient device, and the second version of the program is a program upgraded from the first version of the program, the second version of the program any one of multiple versions of the program issued after the first version of the program.

42. The program upgrade system of claim 31, wherein the upgrade package processor comprises:
a comparator for comparing the first version and the second version of the program in units of a block;
an install data generator for generating install data having upgrade data for merging blocks of the second version and blocks of the first version of the program; and
a package generator for creating the upgrade package by merging the upgrade data containing map data for mapping the blocks of the second version to blocks of the first version of the program and the history data for indicating a relationship between the upgrade package and the first version of the program.

43. The program upgrade system of claim 42, wherein the recipient device comprises:
an installer for extracting the map data from the upgrade package and installing the upgrade package containing the history data, the map data, and the upgrade data within an upgrade package storage region of the first memory based on the map data; and
a translator for generating the second version of the program by merging the upgrade data and the first version of the program based on the map data and loading the second version of the program into the second memory.

44. The program upgrade system of claim 43, wherein the upgrade command is generated when the recipient device is initialized or by a key input, and a last issued upgrade package among multiple upgrade packages is selected for upgrading the program.

45. The program upgrade system of claim 44, wherein the upgrade data includes at least one of copy block data structured in a string of [start block No][number of blocks], modify block data structured in a string of [start block No][number of blocks][data], and shift block data [start block No][number of blocks][previous version position], wherein the [start block No] field has a block index of a start block, the [number of blocks] field has a value indicating a number of blocks from the start block, the [data] field contains data of corresponding block, and the [previous version position] field has a start block index for the blocks to be shifted.

46. The program upgrade system of claim 45, wherein the [previous version position] field indicates one of a block number of the second version of the program±a number of blocks and a block number of the second version−a block number of the first version of the program.
